(19) United States
(12) Patent Application Publication
(10) Pub. No.: US 2024/0396480 A1
(43) Pub. Date: Nov. 28, 2024

(54) AC ROTARY MACHINE CONTROLLER, VEHICLE DRIVING APPARATUS, AND ELECTRIC POWER STEERING APPARATUS

(71) Applicant: Mitsubishi Electric Corporation, Tokyo (JP)

(72) Inventor: Akira FURUKAWA, Tokyo (JP)

(73) Assignee: Mitsubishi Electric Corporation, Tokyo (JP)

(21) Appl. No.: 18/688,541

(22) PCT Filed: Oct. 22, 2021
(86) PCT No.: PCT/JP2021/039109

§ 371 Date: Mar. 1, 2024

(51) Int. Cl. H02P 21/05; B60L 15/20; B62D 5/04; H02P 27/12

(52) U.S. Cl. CPC H02P 21/05; B60L 15/20; B62D 5/0409; B62D 5/046; H02P 27/12; B60L 2220/14; B60L 2240/427

(57) ABSTRACT

To provide an AC rotary machine controller, a vehicle apparatus, and an electric power steering apparatus which can achieve appropriately reduction of the ripple component of the bus current, reduction of the ripple component of the winding current of each phase, or reduction of the switching loss. An AC rotary machine controller controls an AC rotary machine provided with one set or a plurality of sets of three-phase windings; switches a first control mode, a second control mode, and a third control mode, based on an operating state of the AC rotary machine, for each set; executes a phase current ripple suppression control in the first control mode; executes a bus current ripple suppression control in the second control mode; and executes a switching loss suppression control in the third control mode.

### TECHNICAL FIELD

The present disclosure relates to an AC rotary machine controller, a vehicle driving apparatus, and an electric power steering apparatus.

### BACKGROUND ART

In the rotary electric machine control system of patent document 1, the drive method with the lowest loss is selected by comparing the losses when one or both of the first inverter and the second inverter are operated.

In the power converter of patent document 2, in order to avoid the mode in which two sets of inverters become the effective voltage vector at the same time, the carrier wave signal is shifted by 90 degrees at the time of modulation by the third order harmonic wave superposition, and the ripple component of the bus current is reduced. By shifting the two carrier wave signals by 180 degrees mutually, and applying the modulation so that the first set and the second set of voltage command values are coincided with the minimum value of the carrier wave signal, the ripple component of the bus current is reduced.

In the power converter of patent document 3, the switching operation of the phase of the maximum value in the absolute values of winding currents of three-phase is stopped; and for two phases other than the maximum phase, by making the carrier wave signal compared with the voltage command value of one phase different from the carrier wave signal compared with the voltage command value of the other phase, the current of the maximum phase is prevented from flowing into the bus line, and the ripple component of bus current is reduced.

### CITATION LIST

### Patent Literature

Patent document 1: JP 2020-18148 A
Patent document 2: JP 2011-188674 A
Patent document 3: JP 2020-137232 A

### SUMMARY OF INVENTION

### Technical Problem

However, in the control method of patent document 1, in order to select the drive method of the loss minimum, it is necessary to calculate and compare the loss when using only the first inverter, the loss when using only the second inverter, and the loss when using both. When calculating constantly during operation, the processing load increases.

The ripple component of the bus current can be suppressed by using the control method of patent document 2. However, considering the mutual inductance between two sets, the current change of second set is caused when the effective voltage vector of first set is outputted, and the current change of first set is caused when the effective voltage vector of second set is outputted. That is, since it becomes the condition similar to the increase in the interval of the effective voltage vector seemingly, the ripple component of the winding current of each phase becomes large, and the loss becomes large.

The ripple component of the bus current can be suppressed by using the control method of patent document 3. However, since the output interval of the effective voltage vector increases compared with the case where the same carrier wave signal is used between phases, the ripple component of the winding current of each phase becomes large, and the loss becomes large.

Then, the purpose of the present disclosure is to provide an AC rotary machine controller, a vehicle driving apparatus, and an electric power steering apparatus which can achieve appropriately reduction of the ripple component of the bus current, reduction of the ripple component of the winding current of each phase, or reduction of the switching loss.

### Solution to Problem

An AC rotary machine controller according to the present disclosure is an AC rotary machine controller that controls an AC rotary machine having a stator provided with one set or a plurality of sets of three-phase windings via one set or a plurality of sets of inverters, the AC rotary machine controller including:
a voltage command calculation unit that, for each set, calculates voltage command values of three-phase applied to the three-phase windings; and
a PWM control unit that, for each set, controls on/off a plurality of switching devices of the inverter, based on a comparison result between each of the voltage command values of three-phase and a carrier wave signal;
wherein, for each set, the voltage command calculation unit switches a first control mode, a second control mode, and a third control mode, based on an operating state of the AC rotary machine;
in the first control mode, the voltage command calculation unit executes a phase current ripple suppression control that calculates the voltage command values of three-phase by applying a modulation to basic voltage command values of three-phase so that a ripple component of current flowing into the winding of each phase decreases less than a case where the basic voltage command values of three-phase of sine waves are set as the voltage command values of three-phase;
in the second control mode, the voltage command calculation unit executes a bus current ripple suppression control that calculates the voltage command values of three-phase by applying a modulation to the basic voltage command values of three-phase so that a ripple component of current flowing between a DC power source and the inverter decreases less than a case where the basic voltage command values of three-phase of sine waves are set as the voltage command values of three-phase; and
in the third control mode, the voltage command calculation unit executes a switching loss suppression control that calculates the voltage command values of three-phase by applying a modulation to the basic voltage command values of three-phase so that a loss of the switching devices decreases less than a case where the basic voltage command values of three-phase of sine waves are set as the voltage command values of three-phase.

A vehicle driving apparatus according to the present disclosure, including:
the above AC rotary machine controller,
the AC rotary machine, and
a driving force transmission mechanism that transmits a driving force of the AC rotary machine to wheels of a vehicle.

An electric power steering apparatus according to the present disclosure, including:
the above AC rotary machine controller,
the AC rotary machine, and
a driving force transmission mechanism that transmits a driving force of the AC rotary machine to a steering apparatus of a vehicle.

### Advantage of Invention

According to the AC rotary machine controller, the vehicle driving apparatus, and the electric power steering apparatus of the present disclosure, the first control mode in which the phase current ripple suppression control is executed, the second control mode in which the bus current ripple suppression control is executed, and the third control mode in which the switching loss suppression control is executed are switched appropriately based on the operating state of the AC rotary machine. Then, the reduction of the ripple component of the bus current, the reduction of the ripple component of the winding current of each phase, or the reduction of switching loss can be achieved appropriately.

### BRIEF DESCRIPTION OF THE DRAWINGS

FIG. 1 is a schematic configuration diagram of the AC rotary machine, the inverter, and the controller, according to Embodiment 1;

FIG. 2 is a schematic block diagram of the controller, according to Embodiment 1;

FIG. 3 is a hardware configuration diagram of the controller, according to Embodiment 1;

FIG. 4 is a time chart for explaining the PWM control using the carrier wave signal, according to Embodiment 1;

FIG. 5 is a figure for explaining the voltage vector, according to Embodiment 1;

FIG. 6 is a time chart for explaining the PWM control using two carrier wave signals with different phases, according to Embodiment 1;

FIG. 7 is a flowchart for explaining the modulation in the bus current ripple suppression control, according to Embodiment 1;

FIG. 8 is a figure for explaining switching of the carrier wave signal in the case where the power-factor angle is 0 degree in the bus current ripple suppression control, according to Embodiment 1;

FIG. 9 is a figure for explaining switching of the carrier wave signal in the case where the power-factor angle is 60 degrees in the bus current ripple suppression control, according to Embodiment 1;

FIG. 10 is a flowchart for explaining switching of the carrier wave signal in the case of one direction rotation in the bus current ripple suppression control, according to Embodiment 1;

FIG. 11 is a flowchart for explaining switching of the carrier wave signal in the case of the other direction rotation in the bus current ripple suppression control, according to Embodiment 1;

FIG. 12 is a figure for explaining another example of switching of the carrier wave signal in the bus current ripple suppression control, according to Embodiment 1;

FIG. 13 is a flowchart for explaining the switching loss suppression control, according to Embodiment 1;

FIG. 14 is a flowchart for explaining another example of the switching loss suppression control, according to Embodiment 1;

FIG. 15 is a figure for explaining switching of the control mode, according to Embodiment 1;

FIG. 16 is a figure for explaining switching of the control mode, according to Embodiment 1;

FIG. 17 is a schematic configuration diagram of the vehicle driving apparatus, according to Embodiment 1;

FIG. 18 is a schematic configuration diagram of the electric power steering apparatus, according to Embodiment 1;

FIG. 19 is a schematic configuration diagram of the AC rotary machine, the inverter, and the controller, according to Embodiment 2;

FIG. 20 is a figure for explaining the phase difference between the first set of windings and the second set of windings, according to Embodiment 2;

FIG. 21 is a schematic block diagram of the controller, according to Embodiment 2;

FIG. 22 is a time chart for explaining the third example of the bus current ripple suppression control, according to Embodiment 3; and

FIG. 23 is a time chart for explaining the third example of the bus current ripple suppression control, according to Embodiment 3.

### DETAILED DESCRIPTION OF THE EMBODIMENTS

### 1. Embodiment 1

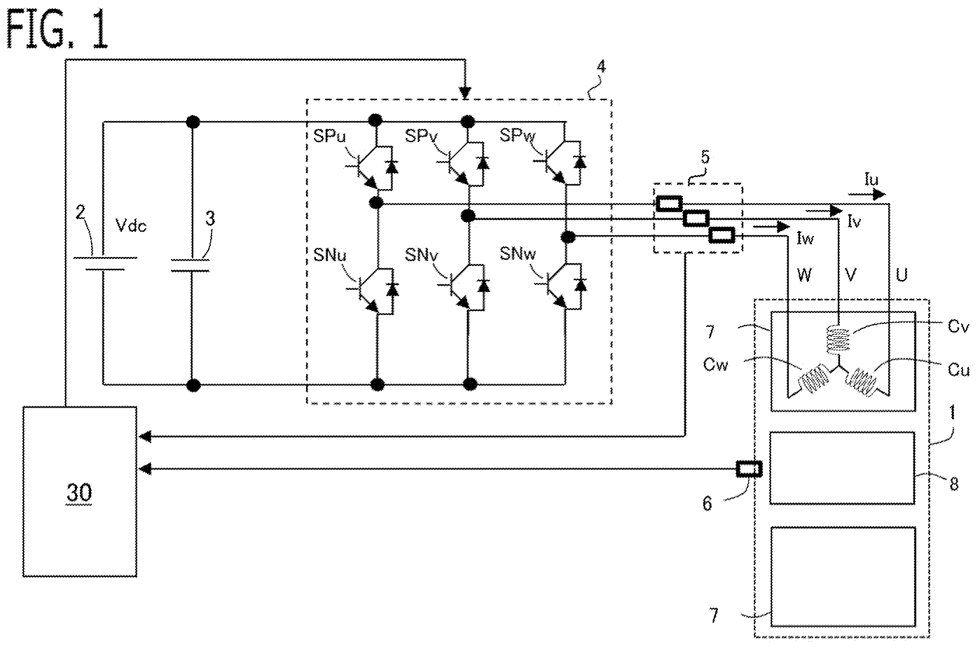

An AC rotary machine controller 30 (hereinafter, referred to simply as a controller 30) according to Embodiment 1 will be explained with reference to drawings. In each figure, the same or corresponding part is explained with the same sign. FIG. 1 is a schematic configuration diagram of an AC rotary machine 1, an inverter 4, and the controller 30 according to the present embodiment.

### 1-1. AC Rotary Machine 1

The AC rotary machine 1 is provided with a stator 7 and a rotor 8 disposed on the radial-direction inner side of the stator 7. The stator 7 is provided with one set of three-phase windings Cu, Cv, Cw. The rotor 8 is provided with a permanent magnet, and the AC rotary machine 1 is a synchronous permanent magnet type synchronous rotary machine. The three-phase windings may be connected by star connection, or may be connected by delta connection. The AC rotary machine 1 may be a field winding type synchronous rotary machine with an electromagnet in the rotor, or may be an induction rotary machine with an iron core in the rotor.

The rotor 8 is provided with a rotation sensor 6 for detecting a rotational angle of the rotor 8. An output signal of the rotation sensor 6 is inputted into the controller 30. Various sensors, such as a Hall element, a resolver, or an encoder, are used for the rotation sensor 6. The rotation sensor 6 may be not provided, and the rotational angle (the magnetic pole position) may be estimated based on current information which are obtained by superimposing a harmonic wave component on the current command value describes below (so-called, sensor less system).

### 1-2. Inverter 4

The inverter 4 is provided with three sets of series circuits (leg) in each of which a high potential side switching device SP connected to the high potential side of the DC power source 2 and a low potential side switching device SN connected to the low high potential side of the DC power source 2 are connected in series, corresponding to each phase of three-phase. A connection node of two switching devices in the series circuit of each phase is connected to the winding of the corresponding phase.

Specifically, in the series circuit of U phase, the high potential side switching device SPu of U phase and the low potential side switching device SNu of U phase are connected in series, and the connection node of two switching devices is connected to the winding Cu of U phase. In the series circuit of V phase, the high potential side switching device SPv of V phase and the low potential side switching device SNv of V phase are connected in series, and the connection node of two switching devices is connected to the winding Cv of V phase. In the series circuit of W phase, the high potential side switching device SPw of W phase and the low potential side switching device SNw of W phase are connected in series, and the connection node of two switching devices is connected to the winding Cw of W phase. A smoothing capacitor 3 is connected between the high potential side and the low potential side of the DC power source 2.

IGBT (Insulated Gate Bipolar Transistor) in which a diode is connected in reversely parallel, MOSFET (Metal Oxide Semiconductor Field Effect Transistor), bipolar transistor in which a diode is connected in reversely parallel, or the like is used for the switching devices. A gate terminal of each switching device is connected to the controller 30 via a gate drive circuit and the like. The each switching device is turned on or off by the switching signals QPu to QNw outputted from the controller 30.

The DC power source 2 outputs a DC voltage Vdc to the inverter 4. The DC power source 2 may be any apparatus which outputs the DC voltage Vdc, such as a battery, a DC-DC converter, a diode rectifier, and a PWM rectifier.

A current sensor 5 which detects current which flows into the winding of each phase is provided. The current sensors 5 is a current sensor, such as shunt resistance or Hall element. An output signal of the current sensor 5 is inputted into the controller 30.

In the present embodiment, the current sensor 5 is provided on the electric wire which connects between the series circuit of the switching devices of each phase, and the winding of each phase. A current detection signal of each phase of the current sensor 5 is inputted into the controller 30. The current sensor 5 may be connected in series to the series circuit of the switching devices of each phase. Alternatively, a current sensor may be provided on the wire which connects between the inverter 4 and the DC power source 2, and the current of the winding of each phase may be detected by well-known “bus line one-shunt method”.

### 1-3. Controller 30

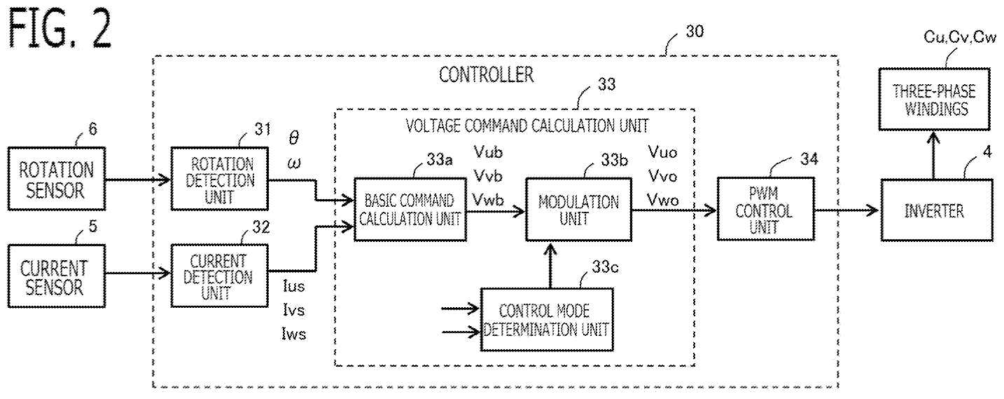

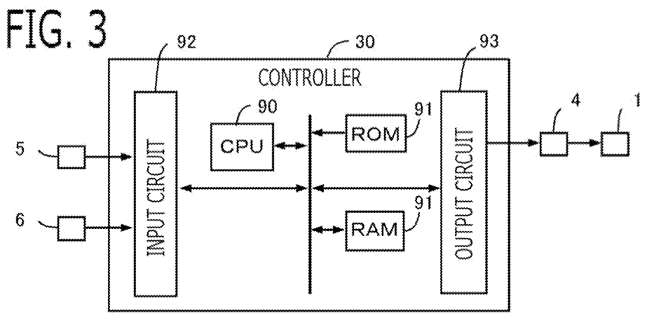

The controller 30 controls the AC rotary machine 1 via the inverter 4. As shown in FIG. 2, the controller 30 is provided with a rotation detection unit 31, a current detection unit 32, a voltage command calculation unit 33, a PWM control unit 34, and the like. Each function of the controller 30 is realized by processing circuits provided in the controller 30. Specifically, as shown in FIG. 3, the controller 30 is provided with, as a processing circuit, an arithmetic processor (computer) 90 such as a CPU (Central Processing Unit), storage apparatuses 91 that exchange data with the arithmetic processor 90, an input circuit 92 that inputs external signals to the arithmetic processor 90, an output circuit 93 that outputs signals from the arithmetic processor 90 to the outside, and the like.

As the arithmetic processor 90, ASIC (Application Specific Integrated Circuit), IC (Integrated Circuit), DSP (Digital Signal Processor), FPGA (Field Programmable Gate Array), various kinds of logical circuits, various kinds of signal processing circuits, and the like may be provided. As the arithmetic processor 90, a plurality of the same type ones or the different type ones may be provided, and each processing may be shared and executed. As the storage apparatuses 91, RAM (Random Access Memory) which can read data and write data from the arithmetic processor 90, ROM (Read Only Memory) which can read data from the arithmetic processor 90, and the like are provided. The input circuit 92 is connected with various kinds of sensors, such as the current sensor 5 and the rotation sensor 6, and is provided with an A/D converter and the like for inputting output signals of these sensors to the arithmetic processor 90. The output circuit 93 is connected with electric loads, such as a gate drive circuit which drive on/off the switching devices, and is provided with a driving circuit and the like for outputting a control signal from the computing processing unit 90.

Then, the arithmetic processor 90 runs software items (programs) stored in the storage apparatus 91 such as ROM and collaborates with other hardware devices in the controller 30, such as the storage apparatus 91, the input circuit 92, and the output circuit 93, so that the respective functions of the control units 31 to 34 provided in the controller 30 are realized. Setting data items such as a determination value to be utilized in the control units 31 to 34 are stored, as part of software items (programs), in the storage apparatus 91 such as ROM. Each function of the controller 30 will be described in detail below.

1-3-1. Rotation detection unit 31

The rotation detection unit 31 detects a rotational angle θ (a magnetic pole position θ of the rotor) and a rotational angle speed @ of the rotor in the electrical angle. In the present embodiment, the rotation detection unit 31 detects the rotational angle θ (the magnetic pole position θ) and the rotational angle speed w in the electrical angle, based on the output signal of the rotation sensor 6. The rotational angle θ is an angle (a position) of the N pole (the magnetic pole) in the electrical angle on the basis of the winding of U phase.

The rotation detection unit 31 may estimate the rotational angle (the magnetic pole position) without using the rotation sensor, based on current information which are obtained by superimposing a harmonic wave component on the current command value (so-called, sensor less system).

### 1-3-2. Current Detection Unit 32

The current detection unit 32 detects three-phase currents Ius, Ivs, Iws which flow into the three-phase windings, based on the output signal of the current sensor 5.

### 1-3-3. PWM Control Unit 34

The PWM control unit 34 controls on/off the plurality of switching devices of the inverter 4, based on a comparison result between each of the voltage command values of three-phase Vuo, Vvo, Vwo calculated by the voltage command calculation unit 33, and a carrier wave signal.

The PWM control unit 34 generates switching signals which turn on and off each switching device by comparing between each of the voltage command values of three-phase Vuo, Vvo, Vwo, and the carrier wave signal C.

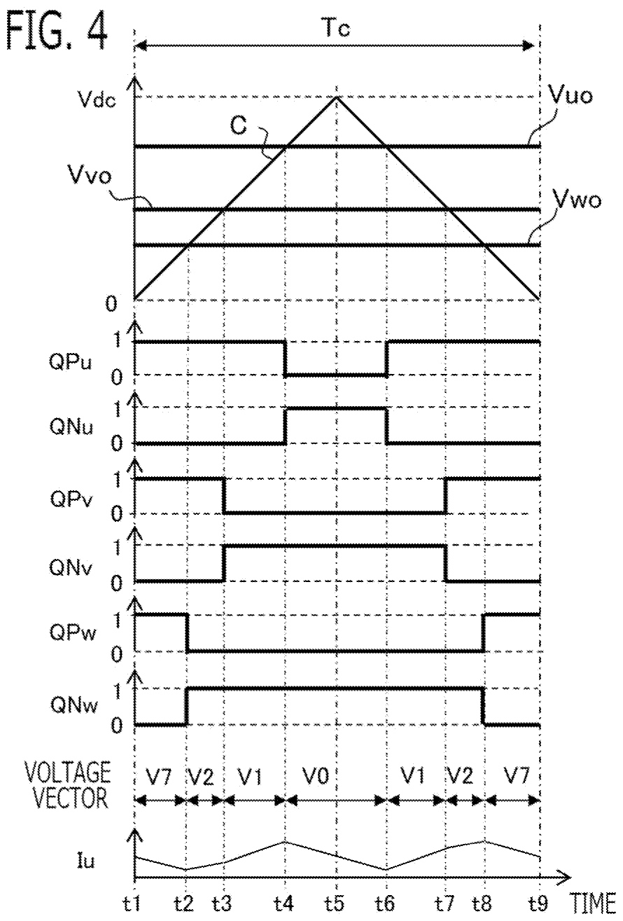

FIG. 4 shows the voltage command values of three-phase Vuo, Vvo, Vwo, the carrier wave signal C, and the switching signal of each switching device, in a PWM period Tc. The carrier wave signal C is a triangular wave which oscillates at the PWM period Tc with an amplitude of a half value Vdc/2 of the DC voltage centering on a center value Vdc/2 of the DC voltage. Any waveforms, such as a saw tooth wave, may be used other than the triangular wave. As described later, in the specific control mode, as the carrier wave signal C, the first carrier wave signal C1 and the second carrier wave signal C2, which are mutually different in the phase of the voltage command value to be compared, may be used.

For each phase, the PWM control unit 34 turns on the switching signal QP of the high potential side switching device SP (in this example, 1) and turns on the high potential side switching device SP, when the carrier wave signal C is less than the voltage command value; and turns off the switching signal QP of the high potential side switching device SP (in this example, 0) and turns off the high potential side switching device SP, when the carrier wave signal C exceeds the voltage command value. On the other hand, for each phase, the PWM control unit 34 turns off the switching signal QN of the low potential side switching device SN (in this example, 0) and turns off the low potential side switching device SN, when the carrier wave signal C is less than the voltage command value; and turns on the switching signal QN of the low potential side switching device SN (in this example, 1) and turns on the low potential side switching device SN, when the carrier wave signal C exceeds the voltage command value.

<Voltage vectors V0 to V7>

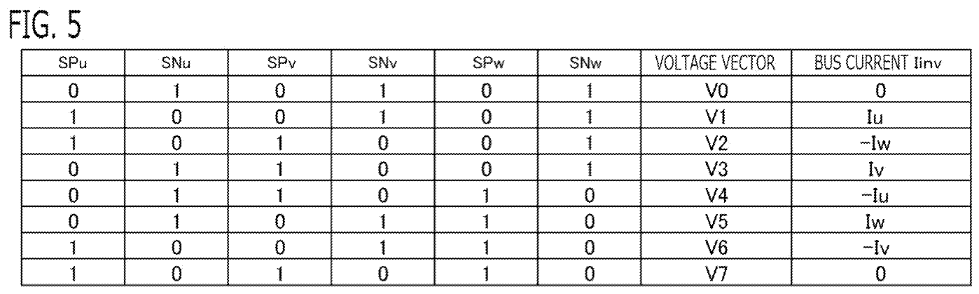

As shown in FIG. 4, in the PWM period Tc, on-off patterns of the six switching devices change, and voltage vectors V0 to V7 corresponding to each on-off pattern switch. As shown in FIG. 5, there are eight on-off patterns of the six switching devices. In FIG. 5, “O” indicates that the corresponding switching device is off, and “1” indicates that the corresponding switching device is on. The eight on-off patterns are referred to as the voltage vectors V0 to V7.

In the voltage vector V0, all of the low potential side switching devices SNu, SNv, SNw of U phase, V phase, and W phase are turned on, and all of the high potential side switching devices SPu, SPv, SPw of U phase, V phase, and W phase are turned off. And, the terminals of the three-phase windings Cu, Cv, Cw is mutually connected via the electric wire on the low potential side. In this voltage vector V0, current circulates between the three-phase windings and the inverter, and it becomes a state of a zero vector in which a bus current Iinv which flows between the DC power source 2 and the inverter 4 becomes zero.

In the voltage vector V7, all of the high potential side switching devices SPu, SPv, SPw of U phase, V phase, and W phase are turned on, and all of the low potential side switching devices SNu, SNv, SNw of U phase, V phase, and W phase are turned off. And, the terminals of the three-phase windings Cu, Cv, Cw is mutually connected via the electric wire on the high potential side. In this voltage vector V7, current circulates between the three-phase windings and the inverter, it becomes a state of the zero vector in which the bus current Iinv which flows between the DC power source 2 and the inverter 4 becomes zero.

In other voltage vectors V1 to V6, the bus current Iinv becomes equal to any one of the currents Iu, Iv, Iw which flow through the windings of U phase, V phase, and W phase. In these voltage vectors V1 to V6, it becomes a state of an effective vector in which the bus current Iinv which flows between the DC power source 2 and the inverter 4 does not become zero.

<Switching of voltage vectors>

In the case of FIG. 4, the voltage vector is V7 in the time t1 to t2 and t8 to t9, is V2 in t2 to t3 and t7 to t8, is V1 in t3 to t4 and t6 to t7, and is V0 in t4 to t6. The winding current Iu of U phase increases at a slope according to the applied voltage at the time of V1 and V2 which are the effective voltage vectors, and decreases toward 0 at the time of V0 and V7 which are the zero voltage vectors. Since there are two increases and decreases in the PWM period Tc, the amplitude becomes small and the ripple component of the winding current decreases. On the other hand, when the power-factor angle is 0 degree where Iu>Iv>Iw, the bus current Iinv changes in a range of 0 to Iu, so the ripple component of the bus current becomes large.

<When using two carrier wave signals which differ in phase by 180 degrees>

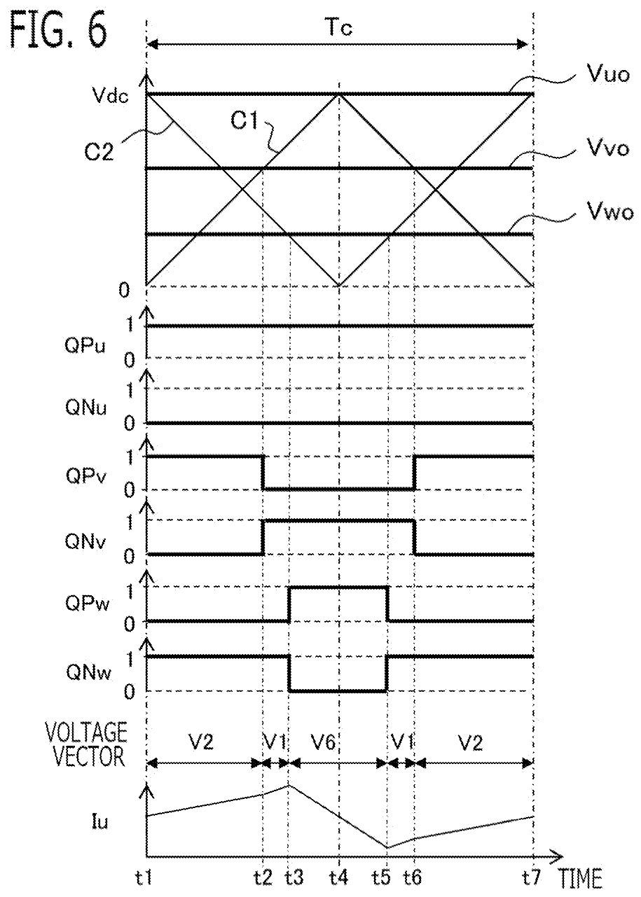

As shown in FIG. 6, as the carrier wave signal, a first carrier wave signal C1, and a second carrier wave signal C2 which differs from the first carrier wave signal C1 by 180 degrees in phase may be used. In the example of FIG. 6, the voltage command value Vvo of V phase is compared with the first carrier wave signal C1, and the voltage command value Vwo of W phase is compared with the second carrier wave signal C2. The voltage command value Vvo of U phase coincides with the maximum value Vdc of the carrier wave signal, and even if compared with either the first or the second carrier wave signal C1, C2, the high potential side switching device SPu of U phase is turned on constantly, and the low potential side switching device SNu of U phase is turned off constantly.

In the case of FIG. 6, the voltage vector is V2 in the time t1 to t2 and t6 to t7, is V1 in t2 to t3 and t5 to t6, and is V6 in t3 to t5. The interval of the zero voltage vector which existed in FIG. 4 is disappeared, and the bus current ripple can be reduced. On the other hand, for the winding current Iu of U phase, each interval of the effective voltage vector becomes longer compared with FIG. 4, and it increases and decreases once in the PWM period Tc. Accordingly, the amplitude becomes large, and the ripple component of the winding current increases.

### 1-3-4. Voltage Command Calculation Unit 33

The voltage command calculation unit 33 calculates voltage command values of three-phase Vuo, Vvo, Vwo applied to three-phase windings. In the present embodiment, the voltage command calculation unit 33 is provided with a basic command calculation unit 33a, a modulation unit 33b, and a control mode determination unit 33c.

### 1-3-4-1. Basic Command Calculation Unit 33a

The basic command calculation unit 33a calculates basic voltage command values of three-phase Vub, Vvb, Vwb of sine waves. In the present embodiment, the basic voltage command values of three-phase Vub, Vvb, Vwb are sine waves which oscillate centering on the center value Vdc/2 of the DC voltage supplied to the inverter 4 from the DC power source 2. The basic voltage command values of three-phase Vub, Vvb, Vwb may be sine waves which oscillate centering on zero.

For example, in a calculation of the basic voltage command values of three-phase, a vector control which controls currents on a rotating coordinate system of d-axis and q-axis is used. The rotating coordinate system of d-axis and q-axis is a rotating coordinate system of two-axis which consist of d-axis defined in the direction of the N-pole (the magnetic pole position θ) and q-axis defined in a direction which advanced to the d-axis by 90 degrees in the electrical angle.

The basic command calculation unit 33a converts the current detection values of three-phase Ius, Ivs, Iws into a current detection value of d-axis Ids and a current detection value of q-axis Iqs, by performing well-known the three-phase/two-phase conversion and the rotating coordinate conversion based on the magnetic pole position θ. The basic command calculation unit 33a calculates a current command value of d-axis Ido and a current command value of q-axis Iqo using various kinds of well-known methods. Then, the basic command calculation unit 33a calculates a voltage command value of d-axis Vdo and a voltage command value of q-axis Vqo by performing well-known current feedback control, based on the current command values of d-axis and q-axis Ido, Iqo, and the current detection values of d-axis and q-axis Ids, Iqs. The basic command calculation unit 33a may calculate the voltage command value of d-axis Vdo and the voltage command value of q-axis Vqo by well-known feedforward control based on the current command values of d-axis and q-axis Ido, Iqo.

Then, the basic command calculation unit 33a calculates the basic voltage command values of three-phase Vub, Vvb, Vwb by performing well-known the fixed coordinate conversion and the two-phase/three-phase conversion to the voltage command values of d-axis and q-axis Vdo, Vqo based on the magnetic pole position θ, and then adding the center value Vdc/2 of the DC voltage.

The basic voltage command values of three-phase may be calculated using other well-known control methods such as the V/f control.

### 1-3-4-2. Modulation Unit 33b

The modulation unit 33b calculates the voltage command values of three-phase Vuo, Vvo, Vwo by applying a modulation to the basic voltage command values of three-phase Vub, Vvb, Vwb. In the present embodiment, the modulation unit 33b executes a phase current ripple suppression control, when a first control mode is selected by the control mode determination unit 33c described below; executes a bus current ripple suppression control, when a second control mode is selected by the control mode determination unit 33c; and executes a switching loss suppression control, when a third control mode is selected by the control mode determination unit 33c. Each suppression control will be explained below.

### 1-3-4-2-1. Phase Current Ripple Suppression Control

The phase current ripple suppression control is a control that calculates the voltage command values of three-phase by applying a modulation to the basic voltage command values of three-phase so that a ripple component of the winding current of each phase (referred to also as a phase current) decreases less than a case where the basic voltage command values of three-phase of sine waves are set as the voltage command values of three-phase. The ripple component of the phase current when the phase current ripple suppression control is executed becomes smaller than the ripple component of the phase current when the bus current ripple suppression control is executed, and the ripple component of the phase current when the switching loss suppression control is executed.

In the present embodiment, as shown in the next equation, in the phase current ripple suppression control, the modulation unit 33b calculates a third order harmonic wave Voff which makes a center value between a maximum voltage Vmax and a minimum voltage Vmin in the voltage command values of three-phase coincide with a center value Vdc/2 of the DC voltage; and calculates the voltage command values of three-phase Vuo, Vvo, Vwo by subtracting the third order harmonic wave Voff from the basic voltage command values of three-phase Vub, Vvb, Vwb. As shown in the next equation, the modulation unit 33b selects the maximum voltage Vmax and the minimum voltage Vmin in the basic voltage command values of three-phase Vub, Vvb, Vwb, and calculates the third order harmonic wave Voff which makes the center value of the maximum voltage Vmax and the minimum voltage Vmin coincide with the center value Vdc/2 of the DC voltage.

$$[ Math . 1 ]$$

$$\begin{matrix}V max = MAX ( Vub , Vvb , Vwb ) \\ V min = MIN ( Vub , Vvb , Vwb ) \\ Voff = \frac{( V max + V min )}{2} - \frac{Vdc}{2} \\ Vuo = Vub - Voff \\ Vvo = Vvb - Voff \\ Vwo = Vwb - Voff\end{matrix} \qquad ( 1 )$$

By setting like the equation (1), the middle time between t2 and t4 in FIG. 4 can be coincided with the middle time between t1 and t5, and the middle time between t6 and t8 can be coincided with the middle time between t5 and t9. As a result, the ripple component of the winding current of each phase becomes the minimum. In order to shorten each interval of the effective voltage vector, the same carrier wave signal C is used for the voltage command values of three-phase.

### 1-3-4-2-2. Bus Current Ripple Suppression Control

The bus current ripple suppression control is a control that calculates the voltage command values of three-phase by applying a modulation to the basic voltage command values of three-phase so that a ripple component of the bus current Iinv flowing between the DC power source 2 and the inverter 4 decreases less than a case where the basic voltage command values of three-phase of sine waves are set as the voltage command values of three-phase. The ripple component of the bus current when the bus current ripple suppression control is executed becomes smaller than the ripple component of the bus current when the phase current ripple suppression control is executed, and the ripple component of the bus current when the switching loss suppression control is executed.

### <Modulation of Voltage Command Value>

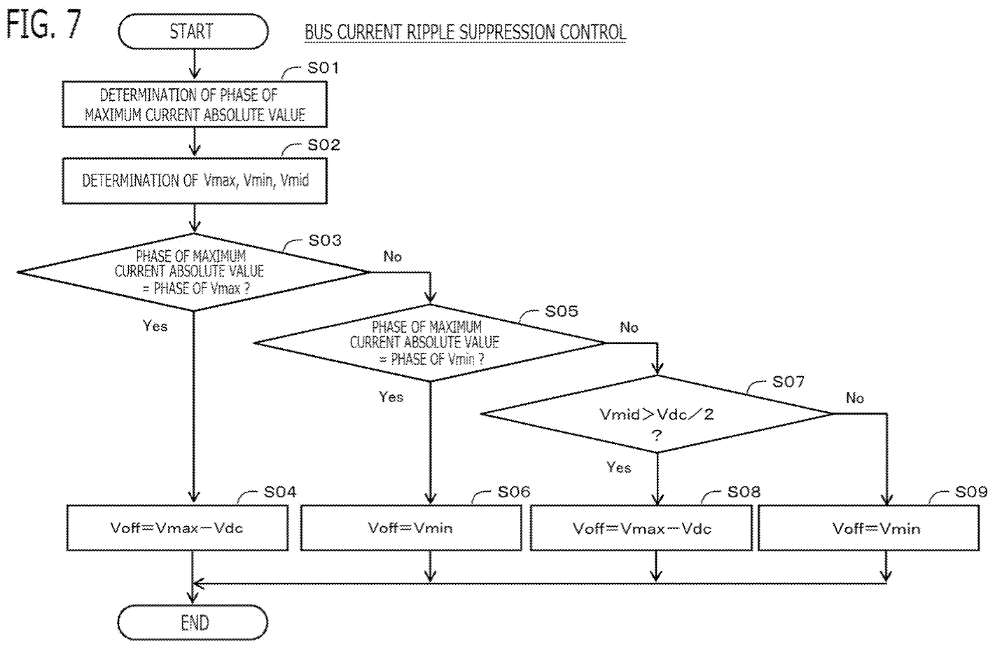

In the present embodiment, the bus current ripple suppression control is performed as shown in the flowchart of FIG. 7, and the equation (2). In the step S01, the modulation unit 33b determines a maximum current absolute value Iabsmax which is a maximum value in absolute values of the winding currents of three-phase, and determines a phase of the maximum current absolute value Iabsmax, based on the current detection values of three-phase Ius, Ivs, Iws. The modulation unit 33b may estimate the winding currents of three-phase based on the voltage command values or the current command values, and may use them for determination.

In the step S02, the modulation unit 33b determines a maximum voltage Vmax, a minimum voltage Vmin, and a middle voltage Vmid in the voltage command values of three-phase. In the present embodiment, the modulation unit 33b determines the maximum voltage Vmax, the minimum voltage Vmin, and the middle voltage Vmid in the basic voltage command values of three-phase Vub, Vvb, Vwb.

In the step S03, the modulation unit 33b determines whether or not a phase of the maximum current absolute value Iabsmax coincides with a phase of the maximum voltage Vmax in the voltage command values of three-phase. When it coincides, it advances to the step S04, and when it does not coincide, it advances to the step S05. In the step S04, the modulation unit 33b executes a flat-top two-phase modulation that calculates an offset voltage Voff which makes the voltage command value of the phase of the maximum voltage Vmax coincide with a maximum value (in this example, Vdc) of the carrier wave signal (Voff=Vmax-Vdc), and calculates the voltage command values of three-phase Vuo, Vvo, Vwo by subtracting the offset voltage Voff from the basic voltage command values of three-phase Vub, Vvb, Vwb.

On the other hand, in the step S05, the modulation unit 33b determines whether or not the phase of the maximum current absolute value Iabsmax coincides with a phase of the minimum voltage Vmin in the voltage command values of three-phase. When it coincides, it advances to the step S06, and when it does not coincide, it advances to the step S07. In the step S06, the modulation unit 33b executes a flat-bottom two-phase modulation that calculates the offset voltage Voff which makes the voltage command value of the phase of the minimum voltage Vmin coincide with a minimum value (in this example, 0) of the carrier wave signal (Voff=Vmin), and calculates the voltage command values of three-phase Vuo, Vvo, Vwo by subtracting the offset voltage Voff from the basic voltage command values of three-phase Vub, Vvb, Vwb.

On the other hand, in the step S07, the phase of the maximum current absolute value Iabsmax does not coincide with the phase of the maximum voltage Vmax and the phase of the minimum voltage Vmin, but the phase of the maximum current absolute value Iabsmax coincides with a phase of the middle voltage Vmid in the voltage command values of three-phase. In this case, the modulation unit 33b determines whether or not the middle voltage Vmid is larger than the center value (in this example, Vdc/2) of the DC voltage supplied to the inverter. When it is larger, it advances to the step S08, and when it is not larger, it advances to the step S09. In the step S08, similarly to the step S04, the modulation unit 33b executes the flat-top two-phase modulation that calculates the offset voltage Voff which makes the voltage command value of the phase of the maximum voltage Vmax coincide with the maximum value (Vdc) of the carrier wave signal (Voff=Vmax-Vdc), and calculates the voltage command values of three-phase Vuo, Vvo, Vwo by subtracting the offset voltage Voff from the basic voltage command values of three-phase Vub, Vvb, Vwb. On the other hand, in the step S09, similarly to the step S06, the modulation unit 33b executes the flat-bottom two-phase modulation that calculates the offset voltage Voff which makes the voltage command value of the phase of the minimum voltage Vmin coincide with the minimum value (0) of the carrier wave signal (Voff=Vmin), and calculates the voltage command values of three-phase Vuo, Vvo, Vwo by subtracting the offset voltage Voff from the basic voltage command values of three-phase Vub, Vvb, Vwb.

$$[ Math . 2 ]$$

$$\begin{matrix}I abs max = MAX ( \vert Ius \vert , \vert Ivs \vert , \vert Iws \vert ) \\ V max = MAX ( Vub , Vvb , Vwb ) \\ V min = MIN ( Vub , Vvb , Vwb ) \\ Vmid = MID ( Vub , Vvb , Vwb ) \\ Voff = V max - Vdc or Voff = V min \\ Vuo = Vub - Voff \\ Vvo = Vvb - Voff \\ Vwo = Vwb - Voff\end{matrix} \qquad ( 2 )$$

When the power-factor angle described below is 0 degree, the phase of maximum current absolute value coincides with the phase of the maximum voltage or the phase of minimum voltage, and does not coincide with the phase of the middle voltage. Accordingly, one of the step S03 or the step S05 is established, and processing of the step S07 to the step S09 is not performed. When the power-factor angle is operated around-30 degrees to 30 degrees, a frequency that the phase of the maximum current absolute value coincides with the phase of the middle voltage is small. Accordingly, processing of the step S07 to the step S09 may be not performed, and instead, processing of the step S04 or the step S06 corresponding to the step S03 or the step S05 established last may be continued.

### <Switching of First and Second Carrier Wave Signals>

When the bus current ripple suppression control is performed, the PWM control unit 34 uses, as the carrier wave signal, a first carrier wave signal C1, and a second carrier wave signal C2 which differs from the first carrier wave signal C1 by 180 degrees in phase. For two phases other than the phase of the maximum voltage Vmax when executing the flat-top two-phase modulation (the phase of the minimum voltage Vmin, the phase of the middle voltage Vmid), or two phases other than the phase of the minimum voltage Vmin when executing the flat-bottom two-phase modulation (the phase of the maximum voltage Vmax, the phase of the middle voltage Vmid), the modulation unit 33b compares the voltage command value of one phase with the first carrier wave signal C1, and compares the voltage command value of the other phase with the second carrier wave signal C2. That is, for the voltage command values of two phases which do not stick to the maximum value (Vdc) or the minimum value (0) of the carrier wave signal by the flat-top two-phase modulation or the flat-bottom two-phase modulation, the modulation unit 33b determines that the voltage command value of one phase is compared with the first carrier wave signal C1, and determines that the voltage command value of the other phase is compared with the second carrier wave signal C2.

In the bus current ripple suppression control, in a region where the amplitude of the voltage command value is low, the maximum current absolute value which is the maximum value in the absolute values of the winding currents of three-phase can be prevented from flowing through the bus line, and the ripple component of the bus current can be reduced.

<Switching of Carrier Wave Signals when Power-Factor Angle is 0 Degree>

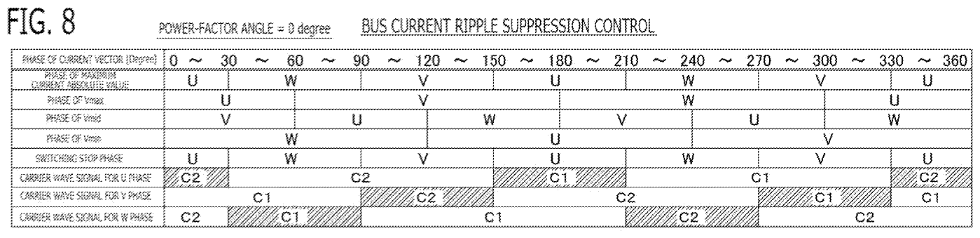

A switching behavior of the carrier wave signals when the power-factor angle is 0 degree will be explained. The power-factor angle is a phase difference of the current vector with respect to the voltage vector. When the power-factor angle is 0 degree, the phase of the voltage vector coincides with the phase of the current vector. When the power-factor angle is 0 degree, as shown in FIG. 8, by switching the first carrier wave signal C1 and the second carrier wave signal C2 according to the phase of the current vector (corresponding to the phase of maximum current absolute value), switching of the carrier wave signals and reflection of the applied voltage can be performed without synchronizing.

The current vector is a current vector obtained by performing the three-phase/two-phase conversion to the winding currents of three-phase, and the phase of the current vector is a phase of the current vector with respect to the winding position of U phase.

By setting the first and the second carrier wave signals C1, C2 as shown in FIG. 8, a switching frequency of the carrier wave signal can be decreased. Specifically, as shown in FIG. 8, the carrier wave signal which is compared with the voltage command value Vuo of U phase is switched to the first carrier wave signal C1 in 210 to 330 degrees of the phase of the current vector, and is switched to the second carrier wave signal C2 in 30 to 150 degrees. The carrier wave signal which is compared with the voltage command value Vvo of V phase is switched to the first carrier wave signal C1 in 0 to 90 degrees, and 330 to 360 degrees, and is switched to the second carrier wave signal C2 in 150 to 270 degrees. The carrier wave signal which is compared with the voltage command value Vwo of W phase is switched to the first carrier wave signal C1 in 90 to 210 degrees, and is switched to the second carrier wave signal C2 in 0 to 30 degrees, and 270 to 360 degrees.

That is, in each phase, the first carrier wave signal C1 and the second carrier wave signal C2 are switched every 120 degrees, and a stop interval of the switching operation shown by hatching is interposed between the interval of the first carrier wave signal C1, and the interval of the second carrier wave signal C2. In the stop interval of switching operation, the voltage command value sticks to the maximum value or the minimum value of the carrier wave signal (flat-top, flat-bottom), the switching device remains on or off, and the switching operation stops. Accordingly, in the stop interval of switching operation, even if either the first or the second carrier wave signal C1, C2 is set, the switching device remains on or off, and the switching signal does not change.

For example, in the stop interval of each switching operation, if it is a rotation direction which changes from the left to the right of FIG. 8, the carrier wave signal of U phase is switched to the first carrier wave signal C1 in 150 to 210 degrees, and is switched to the second carrier wave signal C2 in 330 to 360 degrees, and 0 to 30 degrees. And, the carrier wave signal of V phase is switched to the first carrier wave signal C1 in 270 to 330 degrees, and is switched to the second carrier wave signal C2 in 90 to 150 degrees. And, the carrier wave signal of W phase is switched to the first carrier wave signal C1 in 30 to 90 degrees, and is switched to the second carrier wave signal C2 in 210 to 270 degrees.

Accordingly, the carrier wave signal of U phase is switched to the first carrier wave signal C1 in 150 to 330 degrees of the phase of the current vector, and is switched to the second carrier wave signal C2 in 330 to 360 degrees, and 0 to 150 degrees. The carrier wave signal of V phase is switched to the first carrier wave signal C1 in 270 to 360 degrees, and 0 to 90 degrees, and is switched to the second carrier wave signal C2 in 90 to 270 degrees. The carrier wave signal of W phase is switched to the first carrier wave signal C1 in 30 to 210 degrees, and is switched to the second carrier wave signal C2 in 210 to 360 degrees, and 0 to 30 degrees.

That is, the modulation unit 33b switches the carrier wave signal of each phase, which is compared with the voltage command value of each phase, to the first carrier wave signal C1 in continuous 180 degrees out of 360 degrees, and switches the carrier wave signal of each phase to the second carrier wave signal C2 in the remaining continuous 180 degrees. Accordingly, the number of switching of the carrier wave signals can be reduced.

For example, when the phase of the current vector is 15 degrees, the phase of the maximum current absolute value becomes U phase. when the phase current ripple suppression control is performed, the interval of the effective voltage vector is minimized, so the set voltage vector becomes V1, V2, and V0, and the bus current becomes Iu, −Iw, and 0, respectively. Since the current Iu of U phase whose current absolute value becomes the maximum flows into the bus line, the bus current ripple becomes large easily as the phase current increases. Therefore, when the absolute value of the current vector is large, the bus current ripple suppression control is performed. When the bus current ripple suppression control is performed, the set voltage vector becomes V2, V6, and V7, and the bus current becomes −Iw, −Iv, and 0, respectively. Since the current Iu of U phase of the maximum current absolute value can be avoid to flow into the bus line, the bus current ripple can be reduced.

<Switching of Carrier Wave Signals when Power-Factor Angle is 60 Degrees>

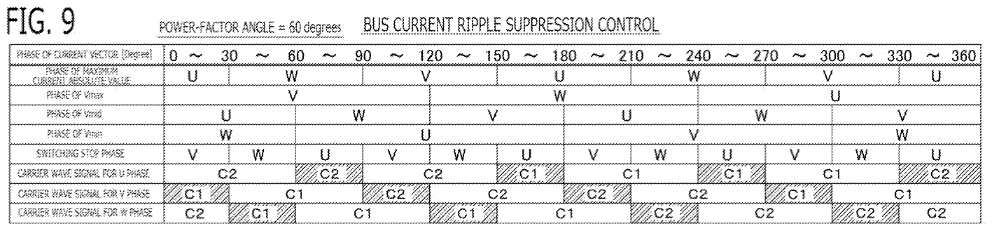

A switching behavior of the carrier wave signals when the power-factor angle is 60 degrees will be explained. The power-factor angle is a phase difference of the current vector with respect to the voltage vector. As shown in FIG. 9, by switching the first carrier wave signal C1 and the second carrier wave signal C2 according to the phase of the current vector (corresponding to the phase of maximum current absolute value), switching of the carrier wave signals and reflection of the applied voltage can be performed without synchronizing.

Specifically, the carrier wave signal which is compared with the voltage command value Vuo of U phase is switched to the first carrier wave signal C1 in 180 to 240 degrees of the phase of the current vector, and 270 to 330 degrees, and is switched to the second carrier wave signal C2 in 0 to 60 degrees, and 90 to 150 degrees. The carrier wave signal which is compared with the voltage command value Vvo of V phase is switched to the first carrier wave signal C1 in 30 to 90 degrees, and 300 to 360 degrees, and is switched to the second carrier wave signal C2 in 120 to 180 degrees, and 210 to 270 degrees. The carrier wave signal which is compared with the voltage command value Vwo of W phase is switched to the first carrier wave signal C1 in 60 to 120 degrees, and 150 to 210 degrees, and is switched to the second carrier wave signal C2 in 0 to 30 degrees, 240 to 300 degrees, and 330 to 360 degrees.

That is, in each phase, every 60 degrees, while interposing the stop interval of switching operation of 30 degrees by the flat-top or the flat-bottom, the carrier wave signal is switched in order of “C1”, “C1”, “C2”, “C2”, “C1”, “C1”, . . . . That is, after one carrier wave signal is set continuously twice, the other carrier wave signal is set continuously twice. In the stop interval of switching operation, even if either carrier wave signal is set, the switching device remains on or off. Accordingly, even if the carrier wave signal is switched during this interval, the switching signal does not change.

For example, in the stop interval of switching operation, if it is a rotation direction which changes from the left to the right of FIG. 9, the carrier wave signal of U phase is switched to the first carrier wave signal C1 in 150 to 180 degrees of the phase of the current vector, and is switched to the second carrier wave signal C2 in 330 to 360 degrees. And, the carrier wave signal of V phase is switched to the first carrier wave signal C1 in 270 to 300 degrees, and is switched to the second carrier wave signal C2 in 90 to 120 degrees. And, the carrier wave signal of W phase is switched to the first carrier wave signal C1 in 30 to 60 degrees, and is switched to the second carrier wave signal C2 in 210 to 240 degrees.

In FIG. 9, the carrier wave signals of two phases whose switching operation is not stopped by the flat-top two-phase modulation or the flat-bottom two-phase modulation become the same during 30 degrees every 60 degrees. That is, for example, in 60 to 90 degrees of FIG. 9, U phase is the switching stop phase, and the carrier wave signals of V phases and W phase other than the switching stop phase are both the first carrier wave signal C1. In 120 to 150 degrees, W phase is the switching stop phase, and the carrier wave signals of U phases and V phase other than the switching stop phase are both the second carrier wave signal C2.

Since the phase between the voltage vector and the current vector is shifted by 60 degrees, in the range where the carrier wave signals of two phases become the same, the phase of the maximum current absolute value becomes the phase of the middle voltage. For example, in 60 to 90 degrees where the carrier wave signals of V phase and W phase become the same, the phase of the maximum current absolute value and the phase of the middle voltage are the same W phase. In 120 to 150 degrees where the carrier wave signals of U phase and V phase become the same, the phase of the maximum current absolute value and the phase of the middle voltage are the same V phase. At this time, if the carrier wave signals of two phases other than the switching stop phase are different, the current of the phase of the maximum current absolute value flows into the bus line, so the bus current ripple becomes large. However, by setting the carrier wave signals of two phases other than the switching stop phase to the same, the current of the phase of the maximum current absolute value can be avoided from flowing into the bus line.

For example, when the phase of the current vector is 15 degrees, the outputted voltage vector becomes V2, V3, and V7, and the bus current becomes −Iw1, Iv1, and 0, respectively. Accordingly, since the current Iu of U phase whose current absolute value becomes the maximum can be avoided from flowing into the bus line, the bus current ripple can be reduced. When the phase of a current vector is 45 degrees, the outputted voltage vector becomes V1, V3, and V0, and the bus current becomes Iu1, Iv1, and 0, respectively. Accordingly, since the current Iw of W phase whose current absolute value becomes the maximum can be avoided from flowing into the bus line, the bus current ripple can be reduced.

When the power-factor angle is operated around-30 degrees to 30 degrees, a frequency that the phase of the maximum current absolute value coincides with the phase of the middle voltage is small. Accordingly, the processing which sets the carrier wave signals of two phases other than the switching stop phase to the same when the phase of the maximum current absolute value becomes the phase of the middle voltage may not be performed.

Even when the power-factor angle is 60 degrees, similarly to the case where the power-factor angle is 0 degree, the carrier wave signal of U phase is switched to the first carrier wave signal C1 in 150 to 330 degrees of the phase of the current vector, and is switched to the second carrier wave signal C2 in 330 to 360 degrees, and 0 to 150 degrees. The carrier wave signal of V phase is switched to the first carrier wave signal C1 in 270 to 360 degrees, and 0 to 90 degrees, and is switched to the second carrier wave signal C2 in 90 to 270 degrees. The carrier wave signal of W phase is switched to the first carrier wave signal C1 in 30 to 210 degrees, and is switched to the second carrier wave signal C2 in 210 to 360 degrees, and 0 to 30 degrees. That is, the same switching processing can be performed regardless of the change in the power-factor angle.

### <Flowchart of Switching Processing of Carrier Wave at Time of One Direction Rotation>

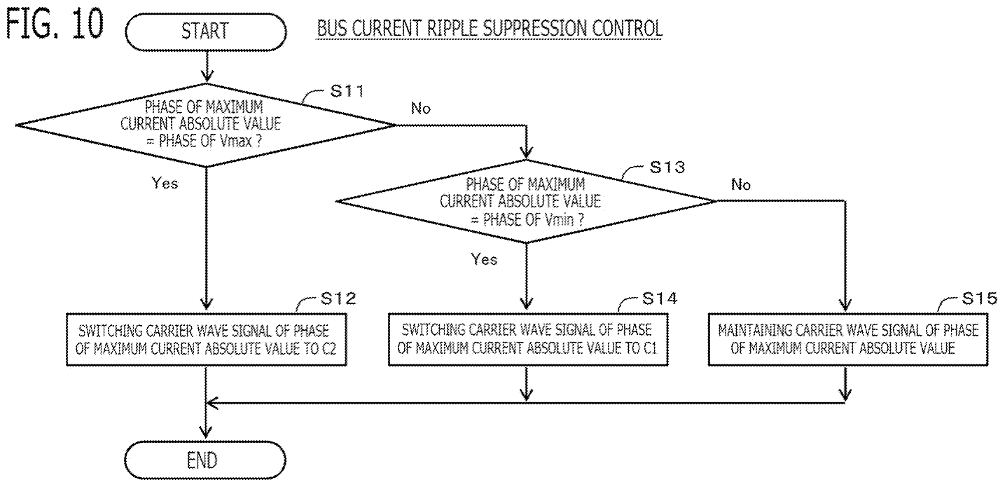

As shown in FIG. 8 and FIG. 9, in order to switch the carrier wave signals when rotating to one direction, for example, the switching processing may be performed according to the flowchart of FIG. 10. In the step S11, the modulation unit 33b determines whether or not the phase of the maximum current absolute value Iabsmax coincides with the phase of the maximum voltage Vmax in the voltage command values of three-phase. When it coincides, it advances to the step S12, and when it does not coincide, it advances to the step S13. In the step S12, the modulation unit 33b switches the carrier wave signal of the phase of the maximum current absolute value to the second carrier wave signal C2.

On the other hand, in the step S13, the modulation unit 33b determines whether or not the phase of the maximum current absolute value Iabsmax coincides with the phase of the minimum voltage Vmin in the voltage command values of three-phase. When it coincides, it advances to the step S14, and when it does not coincide, it advances to the step S15. In the step S14, the modulation unit 33b switches the carrier wave signal of the phase of the maximum current absolute value to the first carrier wave signal C1.

On the other hand, in the step S15, the phase of the maximum current absolute value Iabsmax coincides with the phase of the middle voltage Vmid, and the modulation unit 33b maintains the currently set carrier wave signal of the phase of the maximum current absolute value, without switching.

According to the above processing, when the step S11 is established, the voltage command value of the phase of the maximum current absolute value coincides with the maximum value of the carrier wave signal by the flat-top two-phase modulation, and the switching operation stops. In this state, since the carrier wave signal of the phase of the maximum current absolute value is switched to the second carrier wave signal C2, disturbance of the applied voltage by switching can be suppressed. When the step S13 is established, the voltage command value of the phase of the maximum current absolute value coincides with the minimum value of the carrier wave signal by the flat-bottom two-phase modulation, and the switching operation stops. In this state, since the carrier wave signal of the phase of the maximum current absolute value is switched to the first carrier wave signal C1, disturbance of the applied voltage by switching can be suppressed.

### <Flowchart of Switching Processing of Carrier Wave at Time of Other Direction Rotation>

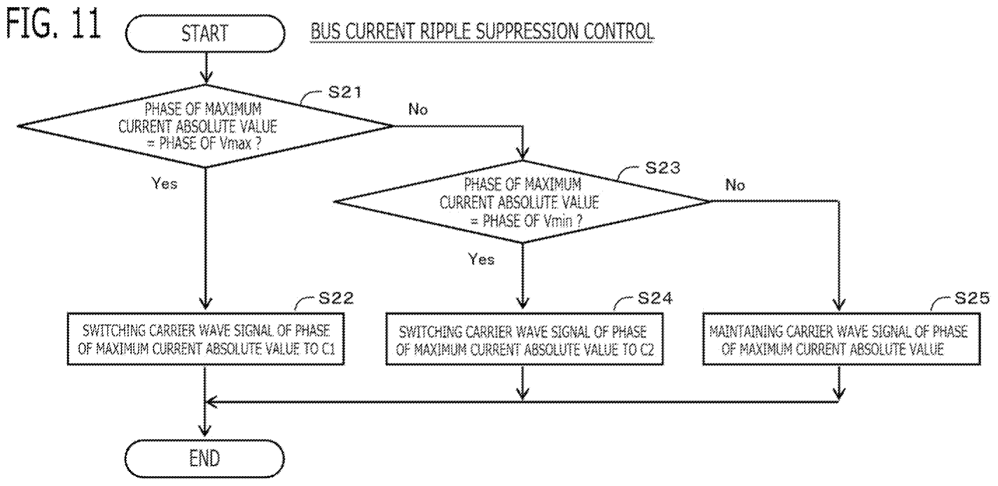

In order to switch the carrier wave signal when rotating to the other direction opposite to FIG. 8 and FIG. 9, for example, the switching processing may be performed according to the flowchart of FIG. 11. In the step S21, the modulation unit 33b determines whether or not the phase of the maximum current absolute value Iabsmax coincides with the phase of the maximum voltage Vmax in the voltage command values of three-phase. When it coincides, it advances to the step S22, and when it does not coincide, it advances to the step S23. In the step S22, the modulation unit 33b switches the carrier wave signal of the phase of the maximum current absolute value to the first carrier wave signal C1.

On the other hand, in the step S23, the modulation unit 33b determines whether or not the phase of the maximum current absolute value Iabsmax coincides with the phase of the minimum voltage Vmin in the voltage command values of three-phase. When it coincides, it advances to the step S24, and when it does not coincide, it advances to the step S25. In the step S24, the modulation unit 33b switches the carrier wave signal of the phase of the maximum current absolute value to the second carrier wave signal C2.

On the other hand, in the step S25, the phase of the maximum current absolute value Iabsmax coincides with the phase of the middle voltage Vmid, and the modulation unit 33b maintains the currently set carrier wave signal of the phase of the maximum current absolute value, without switching.

In FIG. 6, in the PWM period Tc, the first carrier wave signal C1 is a triangular wave projecting upward, and the second carrier wave signal C2 is a triangular wave projecting downward. But, they may be replaced.

### <Another Example of Switching of Carrier Wave Signal>

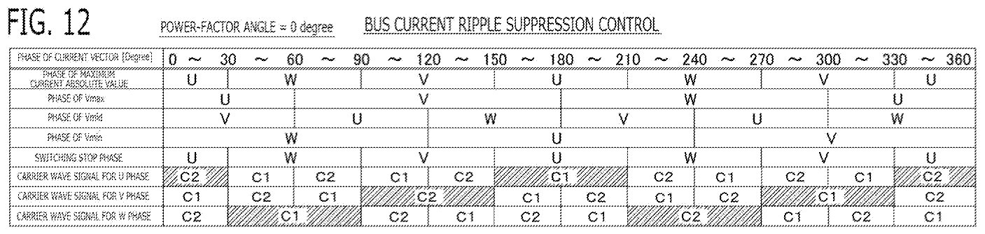

In the above example, the carrier wave signal is switched to the first carrier wave signal C1 in continuous 180 degrees, and is switched to the second carrier wave signal C2 in the remaining continuous 180 degrees. But, the first carrier wave signal C1 and the second carrier wave signal C2 may be switched every a different period. For example, as shown in FIG. 12, the first carrier wave signal C1 and the second carrier wave signal C2 may be switched every 30 degrees period. Other than the 30 degrees period, any period, such as 60 degrees period, may be set. Even in this case, as described above, for two phases other than the phase of the maximum voltage when executing the flat-top two-phase modulation, or two phases other than the phase of the minimum voltage when executing the flat-bottom two-phase modulation, the modulation unit 33b compares the voltage command value of one phase with the first carrier wave signal C1, and compares the voltage command value of the other phase with the second carrier wave signal C2.

### 1-3-4-2-3. Switching Loss Suppression Control

The switching loss suppression control is a control that calculates the voltage command values of three-phase by applying a modulation to the basic voltage command values of three-phase so that a loss of the switching devices decreases less than a case where the basic voltage command values of three-phase of sine waves are set as the voltage command values of three-phase. The loss of the switching devices when executing the switching loss suppression control becomes smaller than the loss of the switching devices when executing the phase current ripple suppression control, and the loss of the switching devices when executing the bus current ripple suppression control.

In the present embodiment, in the switching loss suppression control, as shown in the next equation, the modulation unit 33b calculates an offset voltage Voff which makes the voltage command value of the phase of the maximum voltage Vmax in the voltage command values of three-phase coincide with the maximum value (in this example, Vdc) of the carrier wave signal, or which makes the voltage command value of the phase of the minimum voltage Vmin in the voltage command values of three-phase coincide with the minimum value (in this example, 0) of the carrier wave signal; and calculates the voltage command values of three-phase Vuo, Vvo, Vwo by subtracting the offset voltage Voff from the basic voltage command values of three-phase Vub, Vvb, Vwb.

$$[ Math . 3 ]$$

$$\begin{matrix}V max = MAX ( Vub , Vvb , Vwb ) \\ V min = MIN ( Vub , Vvb , Vwb ) \\ Voff = V max - Vdc or Voff = V min \\ Vuo = Vub - Voff \\ Vvo = Vvb - Voff \\ Vwo = Vwb - Voff\end{matrix} \qquad ( 3 )$$

According to this configuration, the voltage command value of the phase of the maximum voltage Vmax or the minimum voltage Vmin can be coincided with the maximum value or the minimum value of the carrier wave signal, the switching operation of the high potential side and the low potential side switching devices of this phase can be stopped, and the switching loss can be reduced.

### <First Example of Switching of Flat-Top and Flat-Bottom>

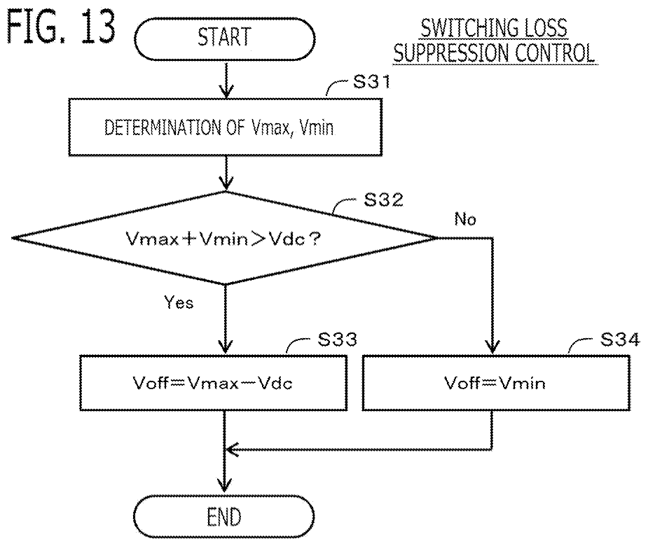

In the present embodiment, the switching loss suppression control is performed as shown in the flowchart of FIG. 13. In the step S31, the modulation unit 33b determines the maximum voltage Vmax, and the minimum voltage Vmin in the voltage command values of three-phase. In the present embodiment, the modulation unit 33b determines the maximum voltage Vmax, and the minimum voltage Vmin in the basic voltage command values of three-phase Vub, Vvb, Vwb.

In the step S32, the modulation unit 33b determines whether or not a total value of the maximum voltage Vmax and the minimum voltage Vmin is larger than a double value (in this example, Vdc) of the center value of the DC voltage. When it is larger, it advances to the step S33, and when it is not larger, it advances to the step S34. If the center value of the DC voltage is set to 0, it is determined whether or not Vmax+Vmin >0. In the step S33, the modulation unit 33b executes the flat-top two-phase modulation that calculates the offset voltage Voff which makes the voltage command value of the phase of the maximum voltage Vmax coincide with the maximum value (in this example, Vdc) of the carrier wave signal (Voff=Vmax-Vdc), and calculates the voltage command values of three-phase Vuo, Vvo, Vwo by subtracting the offset voltage Voff from the basic voltage command values of three-phase Vub, Vvb, Vwb.

On the other hand, in the step S34, the modulation unit 33b executes the flat-bottom two-phase modulation that calculates the offset voltage Voff which makes the voltage command value of the phase of the minimum voltage Vmin coincide with the minimum value (in this example, 0) of the carrier wave signal (Voff=Vmin), and calculates the voltage command values of three-phase Vuo, Vvo, Vwo by subtracting the offset voltage Voff from the basic voltage command values of three-phase Vub, Vvb, Vwb.

In this way, in the step S32, since the flat-top two-phase modulation and the flat-bottom two-phase modulation are switched according to the total value of the maximum voltage Vmax and the minimum voltage Vmin, heat generation can be prevented from being biased toward the high potential side switching device or the low potential side switching device.

### <Second Example of Switching of Flat-Top and Flat-Bottom>

As the current flowing through the switching device becomes large, the switching loss becomes large. Accordingly, by setting the voltage command value of the phase whose absolute value of the winding current becomes large as the flat-top or the flat-bottom, the reduction effect of switching loss can be increased.

When the power-factor angle is around 0 or 180 degrees, the phase whose absolute value of the winding current becomes the maximum, and the phase whose absolute value of the voltage command value becomes the maximum become the same at almost all phases of the current vector. Accordingly, sufficient effect can be obtained by the determination method of switching based on the voltage command values as shown in above FIG. 13. However, when the power-factor angle is around 60,120,240, or 300 degrees, a deviation between the phase whose absolute value of the winding current becomes the maximum, and the phase whose absolute value of the voltage command value becomes the maximum becomes large.

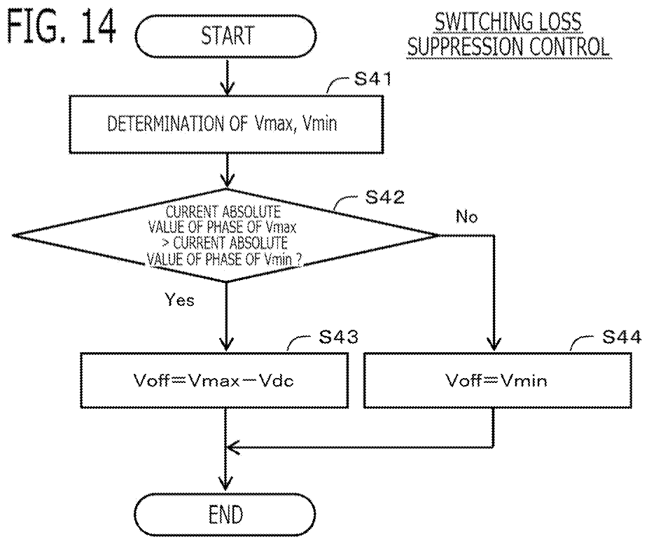

Then, as shown in the flowchart of FIG. 14, the flat-top and the flat-bottom may be switched considering both the voltage command value and the winding current. In the step S41, the modulation unit 33b determines the maximum voltage Vmax, and the minimum voltage Vmin in the voltage command values of three-phase. In the present embodiment, the modulation unit determines the maximum voltage Vmax, and the minimum voltage Vmin in the basic voltage command values of three-phase Vub, Vvb, Vwb.

In the step S42, the modulation unit 33b determines whether or not the absolute value of the winding current of the phase of the maximum voltage Vmax is larger than the absolute value of the winding current of the phase of the minimum voltage Vmin. When it is larger, it advances to the step S43, and when it is not larger, it advances to the step S44. Herein, although the detection values of the winding currents of three-phase Ius, Ivs, Iws are used for the winding current, the winding currents of three-phase estimated based on the voltage command values or the current command values may be used.

In the step S43, the modulation unit 33b executes the flat-top two-phase modulation that calculates the offset voltage Voff which makes the voltage command value of the phase of the maximum voltage Vmax coincide with the maximum value (in this example, Vdc) of the carrier wave signal (Voff=Vmax−Vdc), and calculates the voltage command values of three-phase Vuo, Vvo, Vwo by subtracting the offset voltage Voff from the basic voltage command values of three-phase Vub, Vvb, Vwb.

On the other hand, in the step S44, the modulation unit 33b executes the flat-bottom two-phase modulation that calculates the offset voltage Voff which makes the voltage command value of the phase of the minimum voltage Vmin coincide with the minimum value (in this example, 0) of the carrier wave signal (Voff=Vmin), and calculates the voltage command values of three-phase Vuo, Vvo, Vwo by subtracting the offset voltage Voff from the basic voltage command values of three-phase Vub, Vvb, Vwb.

As explained above, without switching the flat-top two-phase modulation and the flat-bottom two-phase modulation synchronizing with rotation, the flat-top two-phase modulation or the flat-bottom two-phase modulation may be set without synchronizing with rotation (for example, constantly or periodical exchange).

### 1-3-4-3. Control Mode Determination Unit 33C

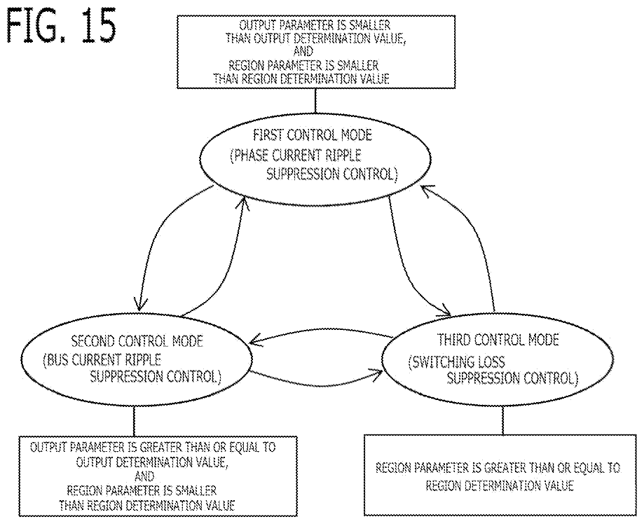

As shown in FIG. 15, the control mode determination unit 33c switches the first control mode, the second control mode, and the third control mode, based on an operating state of the AC rotary machine. There may be other control modes other than the first to third control modes, and the control mode may be switched to other control modes.

As mentioned above, the modulation unit 33b executes the phase current ripple suppression control, when the first control mode is selected; executes the bus current ripple suppression control, the when second control mode is selected; and executes the switching loss suppression control, when the third control mode is selected.

The control mode determination unit 33c switches the first control mode, the second control mode, and the third control mode, based at least on an output parameter which is one of the absolute value (magnitude) of the current vector of the winding currents of three-phase, and an absolute value of an output torque of the AC rotary machine, and a region parameter which is one of an absolute value of the rotational speed of the AC rotary machine and the absolute value of the voltage vector of the voltage command values of three-phase.

According to this configuration, each ripple or loss can be appropriately reduced by switching each control mode based on the output parameter and the region parameter which are related to an increase and decrease in the phase current ripple, an increase and decrease in the bus current ripple, and an increase and decrease in the switching loss.

In the present embodiment, when the output parameter is smaller than an output determination value and the region parameter is smaller than a region determination value, the control mode determination unit 33c switches to the first control mode. When the output parameter is greater than or equal to the output determination value and the region parameter is smaller than the region determination value, the control mode determination unit 33c switches to the second control mode. When the region parameter is greater than or equal to the region determination value, the control mode determination unit 33c switches to the third control mode.

Herein, if the absolute value of the rotational speed or the absolute value of the voltage vector is used as the region parameter, the region parameter is compared with the region determination value.

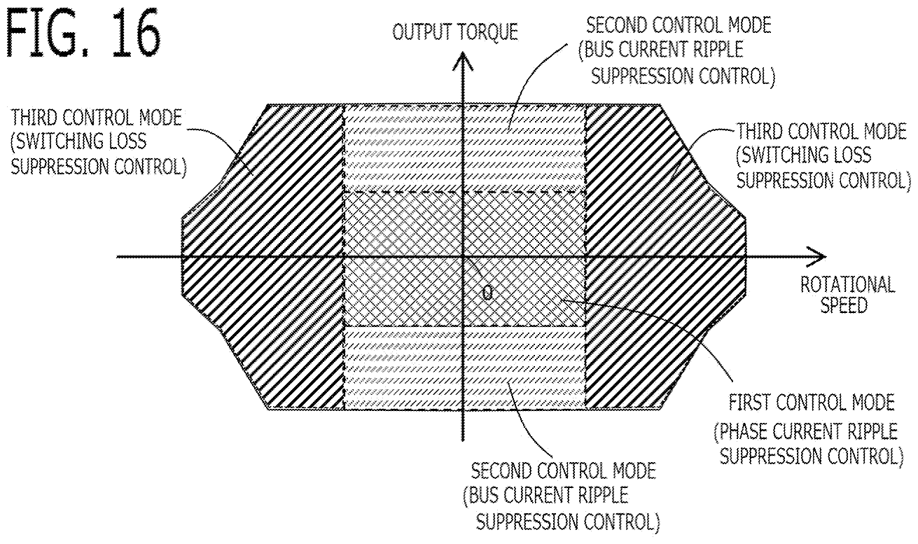

FIG. 16 shows each control mode roughly in the operating region of the AC rotary machine of the output torque and the rotational speed. By referring to a map data in which a relation between the output parameter, the region parameter, and the control mode setting is preliminarily set, the control mode determination unit 33c may determine the control mode corresponding to the present output parameter and the present region parameter. Alternatively, the output determination value may be changed according to specific operating state, such as the region parameter, and the region determination value may be changed according to specific operating state, such as the output parameter. In each quadrant, the output determination value and the region determination value may be changed according to the magnitude of the DC voltage. Finer control mode setting becomes possible.

Since the switching loss becomes large according to the absolute value of the current vector, the heat generation due to the switching loss is reduced by reducing the switching loss in the region where the absolute value of the current vector is large. Then, the selection of the cheap switching device and the simplification of the cooling mechanism becomes possible. When the modulation rate is high, the negative d-axis current is supplied actively in order to suppress the decrease in the output torque, using well-known the magnetic flux weakening control. As a result, since the absolute value of the current vector increases even if not leading to the increase in the output torque, the switching loss becomes large easily when the modulation rate is high. On the other hand, since the induced voltage becomes large when the modulation rate is high, the phase current ripple and the iron loss are small even if the phase current ripple suppression control is not used. Therefore, when the modulation rate is high, the influence of the switching loss becomes relatively larger than the iron loss. In order to improve efficiency, when the modulation rate is high, that is, when the absolute value of the rotational speed or the absolute value of the voltage vector is large, it is preferable to give priority to the reduction of the switching loss.

According to the above configuration, when the region parameter which is one of the absolute value of the rotational speed and the absolute value of the voltage vector becomes larger than the region determination value, the control mode is switched to the third control mode. In this operating state, since the switching loss becomes large relatively as mentioned above, the switching loss can be effectively reduced by the switching loss suppression control.

The ripple component of the bus current which flows into the smoothing capacitor 3 becomes large according to the absolute value of the current vector, and changes according to the power-factor angle. Accordingly, in the region where the absolute value of the current vector becomes large, the capacitor current can be reduced by reducing the ripple component of the bus current, and the smoothing capacitor 3 can be miniaturized. When the ripple component of the bus current is suppressed, the intervals of the effective voltage vector are distributed, so the phase current ripple tends to increase. When a modulation rate is high, the degree of freedom in the arrangement of the intervals of the effective voltage vector is small, and the difference in the ripple component of the bus current due to the method is small. When the modulation rate is high, it is preferable to give priority to the improvement in efficiency and to give priority to the reduction of switching loss.

According to the above configuration, when the region parameter which is one of the absolute value of the rotational speed and the absolute value of the voltage vector becomes larger than the region determination value, the control mode is switched to the third control mode. In this operating state, since the switching loss becomes large relatively as mentioned above, the switching loss can be effectively reduced by the switching loss suppression control.

According to the above configuration, when the output parameter which is one of the absolute value of the current vector and the absolute value of the output torque becomes larger than the output determination value, and the region parameter which is one of the absolute value of the rotational speed and the absolute value of the voltage vector becomes smaller than region determination value, the control mode is switched to the second control mode. In this operating state, since the ripple component of the bus current becomes large as mentioned above, the ripple component of the bus current can be effectively reduced by the bus current ripple suppression control.

The iron loss becomes large as the absolute value of the rotational speed becomes small. By reducing the ripple component of the winding current (the phase current) of each phase in the low rotation speed region, the overall efficiency of the AC rotary machine 1 and the inverter 4 can be improved. According to the above configuration, when the output parameter which is one of the absolute value of the current vector and the absolute value of the output torque becomes smaller than the output determination value, and the region parameter which is one of the absolute value of the rotational speed and the absolute value of the voltage vector becomes smaller than the region determination value, the control mode is switched to the first control mode, and the phase current ripple suppression control is executed. By the phase current ripple suppression control, the ripple component of the phase current can be reduced, the iron loss can be reduced, and efficiency can be improved.

A current vector on a fixed coordinate system of x-axis and β-axis is calculated by performing the three-phase/two-phase conversion to the detection values of the winding currents of three-phase, and a magnitude of the current vector is calculated. The α-axis is defined in the direction of the winding of U phase, and the β-axis is defined in the direction which advanced to the α-axis by 90 degrees in the electrical angle. Alternatively, a magnitude of the current vector of the current detection values of d-axis and q-axis Ids, Iqs, or a magnitude of the current command values of d-axis and q-axis Ido, Iqo may be calculated. Or a current vector may be estimated based on the voltage command values, and a magnitude of the current vector may be calculated.

The output torque of the AC rotary machine is calculated based on the current command values of d-axis and q-axis or the current detection values of d-axis and q-axis. A voltage vector on the fixed coordinate system of the x-axis and the β-axis is calculated by performing the three-phase/two-phase conversion to the voltage command values of three-phase, and a magnitude of the voltage vector is calculated. As a value corresponding to the magnitude of the voltage vector, the so-called voltage utilization factor, the so-called modulation rate, an amplitude of interphase voltages of the voltage command values of three-phase, or the like may be used.

A hysteresis may be provided in each determination, and the determination value or the determination range may be different according to whether each parameter to be determined is positive or negative. Since the ripple component of the bus current, the ripple component of the phase current, and the switching loss change when the DC voltage Vdc changes, the output determination value or the region determination value may be changed according to the DC voltage Vdc.

For example, as the output parameter, the absolute value of the current vector of the winding currents of three-phase is used, and as the region parameter, the absolute value of the rotational speed of the AC rotary machine is used. In this case, as follows, when the absolute value of the current vector is smaller than the output determination value, and the absolute value of the rotational speed is smaller than the region determination value, the control mode is switched to the first control mode. When the absolute value of the current vector is greater than or equal to the output determination value, and the absolute value of the rotational speed is smaller than the region determination value, the control mode is switched to the second control mode. When the absolute value of the rotational speed is greater than or equal to the region determination value, the control mode is switched to the third control mode. As mentioned above, the absolute value of output torque may be used instead of the absolute value of the current vector, and the absolute value of the voltage vector may be used instead of the absolute value of the rotational speed.

First control mode (Phase current ripple suppression control)
| Current vector | < Output determination value
and
| Rotational speed | < Region determination value
Second control mode (Bus current ripple suppression control)
| Current vector | >= Output determination value
and
| Rotational speed | < Region determination value
Third control mode (Switching loss suppression control)
| Rotational speed | >= Region determination value

### 1-4. AC Rotary Machine for Vehicle

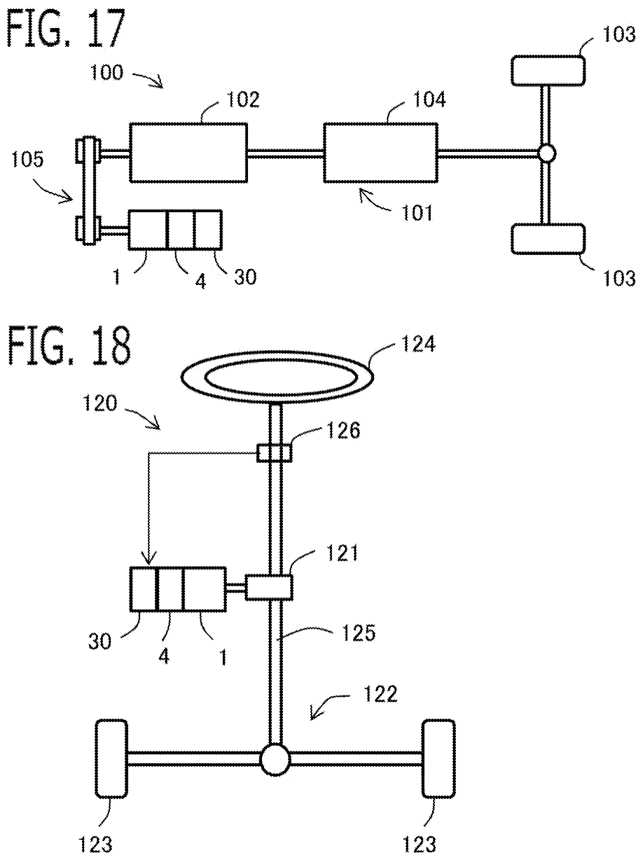

Although an application of the AC rotary machine 1 according to the present embodiment is not limited in particular, a case where the AC rotary machine 1 is used as an AC rotary machine for vehicle will be explained, for example. A vehicle driving apparatus 100 is provided with the AC rotary machine controller 30, the AC rotary machine 1, and a driving force transmission mechanism 101 that transmits a driving force of the AC rotary machine 1 to wheels 103 of a vehicle. As shown in FIG. 17, the vehicle driving apparatus 100 is provided with an internal combustion engine 102, and the AC rotary machine 1 is connected with a crankshaft of the internal combustion engine 102 via a pulley and belt mechanism 105. The rotation axis of the AC rotary machine 1 is connected with the wheels 103 via the internal combustion engine 102 and a transmission 104. The AC rotary machine 1 functions as a motor and becomes a driving force source of the wheels 103 as an auxiliary machine of the internal combustion engine 102; and functions as a generator and generates electricity utilizing rotation of the internal combustion engine 102. The AC rotary machine 1 may be provided between the internal combustion engine 102 and the transmission 104, and may be provided within the transmission 104. The internal combustion engine 102 may not be provided.

Since the rotation of the internal combustion engine 102 and the AC rotary machine 1 becomes in one direction, the rotation in the other direction shown in FIG. 11 need not be considered. In low rotation speed and low current, such as an idling of the internal combustion engine 102, the control mode is set to the first control mode and the phase current ripple suppression control is executed, so the iron loss can be reduced and the generation efficiency can be improved. In high rotational speed, the control mode is set to the third control mode and the switching loss suppression control is executed, so the heat generation of the switching devices can be suppressed, and the continuous operation time can be extended. In low rotation speed and high current with high frequency, the control mode is set to the second control mode and the bus current ripple suppression control is executed, so the capacitor current can be reduced, and the miniaturization of the smoothing capacitor 3 can be achieved.

### 1-3. Electric Power Steering Apparatus

Next, a case where the AC rotary machine 1 is used as a driving force source of the electric power steering apparatus 120 will be explained. The electric power steering apparatus 120 is provided with the AC rotary machine controller 30, the AC rotary machine 1, and a driving force transmission mechanism 121 which transmits the driving force of the AC rotary machine 1 to a steering apparatus of a vehicle. As shown in FIG. 18, the rotation axis of the of the AC rotary machine 1 is connected with a steering apparatus 122 of the wheels via the driving force transmission mechanism 121. For example, the electric power steering apparatus 120 is provided with a handle 124 that a driver rotates right and left, a shaft 125 that is connected with the handle 124 and transmits a steering wheel torque by the handle 124 to the steering apparatus 122 of the wheels 123, a torque sensor 126 that is mounted on the shaft 125 and detects a steering torque by the handle 124, and a driving force transmission mechanisms 121, such as a worm gear mechanism, which connects the rotation axis of the AC rotary machine 1 with the shaft 125. An output signal of the torque sensor 126 is inputted into the controller 30. The controller 30 calculates a torque command value or a current command value, based on the steering torque detected by the torque sensor 126, and calculates the basic voltage command values of three-phase, based on the torque command value or the current command value. The electric power steering apparatus 120 may be a so-called steer by wire system.

Since the AC rotary machine 1 rotates to one direction or the other direction, processing of FIG. 10 and FIG. 11 is used. In low rotation speed and high electric current with high frequency at steering, the control mode is set to the second control mode and the bus current ripple suppression control is executed, so the capacitor current can be reduced and the miniaturization of the smoothing capacitor 3 can be achieved. In low rotation speed and a low current, the control mode is set to the first control mode and the phase current ripple suppression control is executed, so the ripple component of the output torque can be reduced, the vibration transmitted to the driver via the handle 124 can be reduced, and the noise transmitted into an automobile interior can be reduced. In high rotational speed, the control mode is set to the third control mode and the switching loss suppression control is executed, the heat generation of the switching devices can be suppressed, and the continuous operation time can be extended.

### 2. Embodiment 2

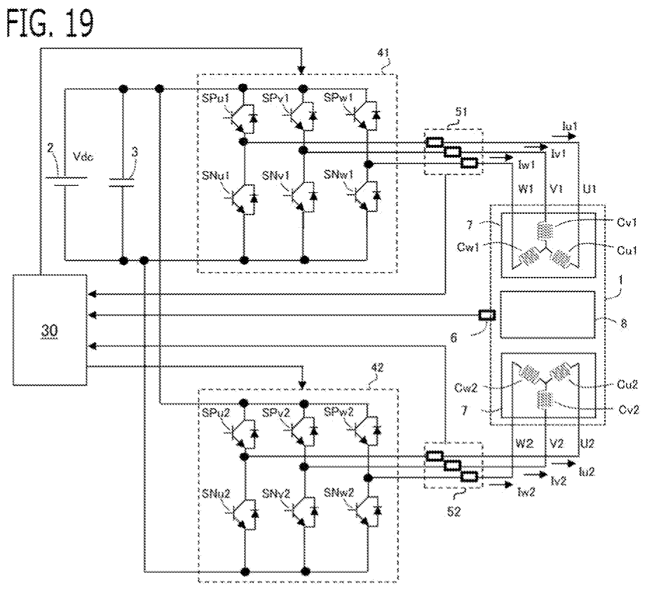

The controller 30 according to Embodiment 2 will be explained with reference to drawings. The explanation for constituent parts the same as those in Embodiment 1 will be omitted. The basic configuration of the AC rotary machine 1, the inverter 4, and the controller 30 according to the present embodiment is the same as that of Embodiment 1. However, as shown in FIG. 19, in the present embodiment, the stator is provided with a plurality of sets (in this example, two sets) of three-phase windings, and a plurality of sets (in this example, two sets) of inverters are provided corresponding to the three-phase windings of each set. The controller 30 controls the AC power supplied to the three-phase windings of each set via the inverter of each set.

In the present embodiment, the one stator 7 is provided with the first set of three-phase windings Cu1, Cv1, Cw1, and the second set of three-phase windings Cu2, Cv2, Cw2. The three-phase windings of each set may be connected by star connection, or may be connected by delta connection. The three-phase of first set is defined as U1 phase, V1 phase, and W1 phase. The three-phase of second set is defined as U2 phase, V2 phase, and W2 phase.

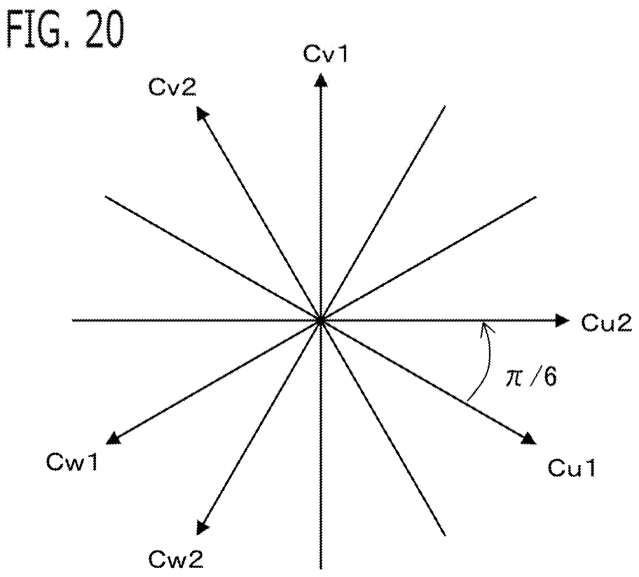

In the present embodiment, as FIG. 20 shows a schematic diagram, a phase difference in the electrical angle of the position of the second set of three-phase windings Cu2, Cv2, Cw2 with respect to the position of the first set of three-phase windings Cu1, Cv1, Cw1 is set to n/6 (30 degrees). The phase difference may be set to any angles.

Similarly to Embodiment 1, the permanent magnet is provided in the rotor 8. A first set of current sensor 51 for detecting current flowing into the first set of three-phase windings Cu1, Cv1, Cw1, and a second set of current sensor 52 for detecting current flowing into the second set of three-phase windings Cu2, Cv2, Cw2 are provided.

A first set of inverter 41 for the first set of three-phase windings and a second set of inverter 42 for the second set of three-phase windings are provided. Since the inverter 41, 42 of each set is similar to the configuration of the inverter 4 in Embodiment 1, explanation is omitted.

The first set of inverter 41 and the second set of inverter 42 are connected to the one DC power source 2. The one smoothing capacitor 3 is connected to the DC power source 2 in parallel. The smoothing capacitor may be provided in each of the first set and the second set of inverters 41, 42.

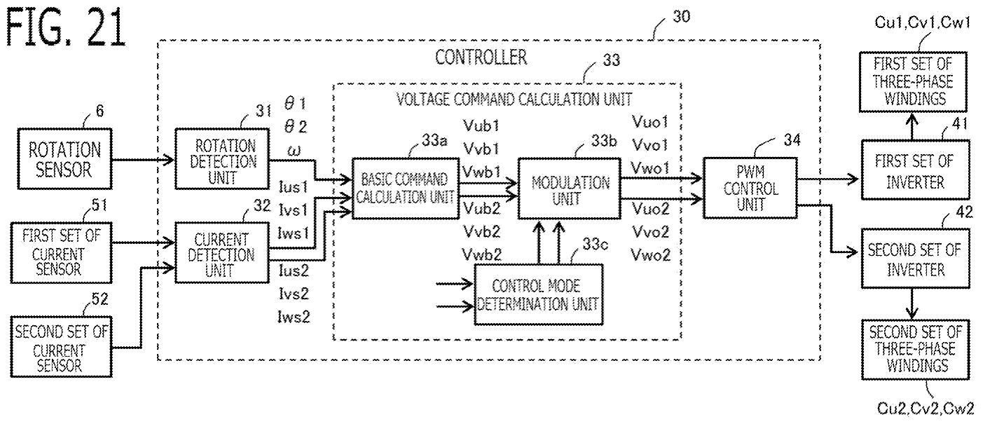

As shown in FIG. 21, the controller 30 controls on/off the switching devices of each of the first set and the second set of inverters 41, 42, and controls the AC power supplied to the three-phase windings of each set. Corresponding to the three-phase windings of each set, a plurality of sets of controllers may be provided.

The rotation detection unit 31 detects a first set of rotational angle θ1 (a first set of magnetic pole position θ1), a second set of rotational angle θ2 (a second set of magnetic pole position θ2), and the rotational angle speed @ in the electrical angle, based on the output signal of the rotation sensor 6. The first set of rotational angle θ1 is an angle (position) of the N pole (magnetic pole) in the electrical angle on the basis of the winding of U1 phase of first set. The second set of rotational angle θ2 is an angle (position) of the N pole (magnetic pole) in the electrical angle on the basis of the winding of U2 phase of second set. It may be the sensor less system.

The current detection unit 32 detects three-phase currents Ius1, Ivs1, Iws1 which flow into the first set of three-phase windings, based on the output signal of the first set of current sensor 51; and detects three-phase currents Ius2, Ivs2, Iws2 which flow into the second set of three-phase windings, based on the output signal of the second set of current sensor 52.

In the present embodiment, for each set, the voltage command calculation unit 33 calculates the voltage command values of three-phase applied to three-phase windings. Basically, the calculation of the voltage command values of three-phase of each set and the switching of the control mode of each set are similar to Embodiment 1.

The voltage command calculation unit 33 calculates first set of voltage command values of three-phase Vuo1, Vvo1, Vwo1, and calculates second set of voltage command values of three-phase Vuo2, Vvo2, Vwo2. In detail, using the method similar to Embodiment 1, the basic command calculation unit 33a calculates first set of basic voltage command values of three-phase Vub1, Vvb1, Vwb1, and calculates second set of basic voltage command values of three-phase Vub2, Vvb2, Vwb2. When calculating the first set of basic voltage command values of three-phase, first set of current detection values of three-phase Ius1, Ivs1, Iws1, and the first set of rotational angle θ1 are used. When calculating the second set of basic voltage command values of three-phase, second set of current detection values of three-phase Ius2, Ivs2, Iws2, and the second set of rotational angle θ2 are used.

For each set, the control mode determination unit 33c switches the first control mode, the second control mode, and the third control mode, based on the operating state of the AC rotary machine.

Specifically, for the first set, the control mode determination unit 33c switches the first control mode, the second control mode, and the third control mode, based at least on an output parameter which is one of an absolute value (magnitude) of a current vector of the first set of winding currents of three-phase, and an absolute value of an output torque of the AC rotary machine by the first set of three-phase windings, and a region parameter which is one of an absolute value of the rotational speed of the AC rotary machine, and an absolute value of a voltage vector of the first set of voltage command values of three-phase.

For the second set, the control mode determination unit 33c switches the first control mode, the second control mode, and the third control mode, based at least on an output parameter which is one of an absolute value (magnitude) of a current vector of the second set of winding currents of three-phase, and an absolute value of an output torque of the AC rotary machine by the second set of three-phase windings, and a region parameter which is one of the absolute value of the rotational speed of the AC rotary machine, and an absolute value of a voltage vector of the second set of voltage command values of three-phase.

Since processing of each set in the control mode determination unit 33c is similar to Embodiment 1, explanation is omitted. In the present embodiment, the electric constants of each set are equivalent, and the output torque of each set by the three-phase windings of each set is set equally. Accordingly, the absolute value of the current vector of each set, the absolute value of the output torque of each set, and the absolute value of the voltage vector of each set become equivalent between sets at normal time. Accordingly, the control mode of each set becomes the same basically.

The modulation unit 33b calculates the first set of voltage command values of three-phase Vuo1, Vvo1, Vwo1 by applying a modulation to the first set of basic voltage command values of three-phase Vub1, Vvb1, Vwb1; and calculates the second set of voltage command values of three-phase Vuo2, Vvo2, Vwo2 by applying a modulation to the second set of basic voltage command values of three-phase Vub2, Vvb2, Vwb2.

For the first set, the modulation unit 33b executes the phase current ripple suppression control, when the first control mode is selected; executes the bus current ripple suppression control, the when second control mode is selected; and executes the switching loss suppression control, when the third control mode is selected. For the second set, the modulation unit 33b executes the phase current ripple suppression control, when the first control mode is selected; executes the bus current ripple suppression control, the when second control mode is selected; and executes the switching loss suppression control, when the third control mode is selected. Since the phase current ripple suppression control, the phase current ripple suppression control, and the switching loss suppression control of each set are similar to Embodiment 1, explanation is omitted.

For each set, the PWM control unit 34 controls on/off the plurality of switching devices of the inverter, based on a comparison result between each of the voltage command values of three-phase and the carrier wave signal. The PWM control unit 34 controls on/off the plurality of switching devices of the first set of inverter 41, based on the comparison result between each of the first set of voltage command values of three-phase Vuo1, Vvo1, Vwo1, and the carrier wave signal. The PWM control unit 34 controls on/off the plurality of switching devices of the second set of inverter 42, based on the comparison result between each of the second set of voltage command values of three-phase Vuo2, Vvo2, Vwo2, and the carrier wave signal. Setting of the carrier wave signal of each set (whether one carrier wave signal or two carrier wave signals with a phase difference is used) is performed based on the control mode of each set.

In the present embodiment, even when the plurality of sets of three-phase windings are provided, for each set, the bus current ripple suppression control, the switching loss suppression control, and the switching loss suppression n control can be switched appropriately based on the operating state, and each ripple or loss can be reduced appropriately.

### 3. Embodiment 3

The controller 30 according to Embodiment 3 will be explained with reference to drawings. The explanation for constituent parts the same as that of Embodiment 1 or 2 will be omitted. In the present embodiment, similarly to Embodiment 2, the plurality of sets of three-phase windings and the plurality of sets of inverters are provided. However, in the present embodiment, utilizing the plurality of sets, a part of the phase current ripple suppression control and the bus current ripple suppression control is changed. Changed parts will be explained mainly.

### <Phase Current Ripple Suppression Control>

In the present embodiment, as shown in the next equation, in the phase current ripple suppression control, the modulation unit 33b calculates a first set of third order harmonic wave Voff1 and a second set of third order harmonic wave Voff2 which makes a center value a between a maximum voltage Vmax1 and a minimum voltage Vmin1 in the first set of voltage command values of three-phase Vuo1, Vvo1, Vwo1, and a center value a between a maximum voltage Vmax2 and a minimum voltage Vmin2 in the second set of voltage command values of three-phase Vuo2, Vvo2, Vwo2 coincide with each other; calculates the first set of voltage command values of three-phase Vuo1, Vvo1, Vwo1 by subtracting the first set of third order harmonic wave Voff1 from the first set of basic voltage command values of three-phase Vub1, Vvb1, Vwb1; and calculates the second set of voltage command values of three-phase Vuo2, Vvo2, Vwo2 by subtracting the second set of third order harmonic wave Voff2 from the second set of basic voltage command values of three-phase Vub2, Vvb2, Vwb2. Herein, the first set of center value a and the second set of center value a are set to the same value. If the center value a is set to the center value Vdc/2 of the DC voltage, it becomes similar to Embodiment 1 or 2.

$$[ Math . 4 ]$$

$$\begin{matrix}V max 1 = MAX ( Vub 1 , Vvb 1 , Vwb 1 ) \\ V min 1 = MIN ( Vub 1 , Vvb 1 , Vwb 1 ) \\ Voff 1 = \frac{( V max 1 + V min 1 )}{2} - α \\ Vuo 1 = Vub 1 - Voff 1 \\ Vvo 1 = Vvb 1 - Voff 1 \\ Vwo 1 = Vwb 1 - Voff 1 \\ V max 2 = MAX ( Vub 2 , Vvb 2 , Vwb 2 ) \\ V min 2 = MIN ( Vub 2 , Vvb 2 , Vwb 2 ) \\ Voff 2 = \frac{( V max 2 + V min 2 )}{2} - α \\ Vuo 2 = Vub 2 - Voff 2 \\ Vvo 2 = Vvb 2 - Voff 2 \\ Vwo 2 = Vwb 2 - Voff 2\end{matrix} \qquad ( 4 )$$

In this way, by setting the first set of center value a and the second set of center value a to the same value, the middle time of the interval of the effective voltage vector can be matched, the phase current ripple can be reduced.

### <First Example of Bus Current Ripple Suppression Control>

In the present embodiment, in the bus current ripple suppression control, the modulation unit 33b executes the flat-bottom two-phase modulation for the second set, when performing the flat-top two-phase modulation for the first set; and executes the flat-top two-phase modulation for the second set, when performing the flat-bottom two-phase modulation for the first set. The modulation unit 33b uses the carrier wave signal with the same phase as the first set of carrier wave signal and the second set of carrier wave signal. The first set of carrier wave signal is compared with the first set of voltage command values of three-phase, and the second set of carrier wave signal is compared with the second set of voltage command values of three-phase.

According to this configuration, in the set in which the flat-top two-phase modulation is performed, the interval of the effective voltage vector appears around the center of the PWM period Tc, and the interval of the zero voltage vector appears around both ends of the PWM period Tc. On the other hand, in the set in which the flat-bottom two-phase modulation is performed, the interval of the zero voltage vector appears around the center of the PWM period Tc, and the interval of the effective voltage vector appears around both ends of the PWM period Tc. Accordingly, the interval of the effective voltage vector can be shifted between sets, and the ripple component of the bus current can be reduced.

Similarly to Embodiment 1 or 2, in the flat-top two-phase modulation, the modulation unit 33b calculates the offset voltage which makes the voltage command value of the phase of the maximum voltage in the voltage command values of three-phase of an object set in which the flat-top two-phase modulation is executed coincide with the maximum value of the carrier wave signal; and calculates the voltage command values of three-phase of the object set by subtracting the offset voltage from the basic voltage command values of three-phase of the object set.

In the flat-bottom two-phase modulation, the modulation unit 33b calculates the offset voltage which makes the voltage command value of the phase of the minimum voltage in the voltage command values of three-phase of an object set in which the flat-bottom two-phase modulation is executed coincide with the minimum value of the carrier wave signal; and calculates the voltage command values of three-phase of the object set by subtracting the offset voltage from the basic voltage command values of three-phase of the object set.

Since the flat-top two-phase modulation and the flat-bottom two-phase modulation of each set become the processing similar to the equation (3), explanation is omitted.

The set in which the flat-top two-phase modulation is performed, and the set in which the flat-bottom two-phase modulation is performed may be replaced periodically. For the first set, as shown in FIG. 7, execution of the flat-top two-phase modulation or the flat-bottom two-phase modulation may be determined; and for the second set, execution of the flat-top two-phase modulation or the flat-bottom two-phase modulation may be determined so as to be the opposite of the first set.

Alternatively, for each of the first set and the second set, as shown in FIG. 7, execution of the flat-top two-phase modulation or the flat-bottom two-phase modulation may be determined. Even in this case, since an interval when the flat-top two-phase modulation and the flat-bottom two-phase modulation are executed at the same time occurs, the ripple component of the bus current is reduced.

### <Second Example of Bus Current Ripple Suppression Control>

Alternatively, in the bus current ripple suppression control, the modulation unit 33b executes the flat-top two-phase modulation for the second set, when performing the flat-top two-phase modulation for the first set; and executes the flat-bottom two-phase modulation for the second set, when performing the flat-bottom two-phase modulation for the first set. The modulation unit 33b uses the first carrier wave signal C1 as the first set of carrier wave signal; and uses the second carrier wave signal C2 which differs from the first carrier wave signal C1 by 180 degrees in phase as the second set of carrier wave signal.

According to this configuration, for the first set and the second set, when the flat-top two-phase modulation is performed, in one set, the interval of the effective voltage vector appears around the center of the PWM period Tc, and the interval of the zero voltage vector appears around the both ends of the PWM period Tc; and in the other set, the interval of the zero voltage vector appears around the center of the PWM period Tc, and the interval of the effective voltage vector appears around both ends of the PWM period Tc. Accordingly, the interval of the effective voltage vector can be shifted between sets, and the ripple component of the bus current can be reduced. For the first set and the second set, when the flat-bottom two-phase modulation is performed, in one set, the interval of the zero voltage vector appears around the center of the PWM period Tc, and the interval of the effective voltage vector appears around both ends of the PWM period Tc; and in the other set, the interval of the effective voltage vector appears around the center of the PWM period Tc, and the interval of the zero voltage vector appears around both ends of the PWM period Tc. Accordingly, the interval of the effective voltage vector can be shifted between sets, and the ripple component of the bus current can be reduced.

Similarly to Embodiment 1 or 2, in the flat-top two-phase modulation, the modulation unit 33b calculates the offset voltage which makes the voltage command value of the phase of the maximum voltage in the voltage command values of three-phase of an object set in which the flat-top two-phase modulation is executed coincide with the maximum value of the carrier wave signal; and calculates the voltage command values of three-phase of the object set by subtracting the offset voltage from the basic voltage command values of three-phase of the object set.

In the flat-bottom two-phase modulation, the modulation unit 33b calculates the offset voltage which makes the voltage command value of the phase of the minimum voltage in the voltage command values of three-phase of an object set in which the flat-bottom two-phase modulation is executed coincide with the minimum value of the carrier wave signal; and calculates the voltage command values of three-phase of the object set by subtracting the offset voltage from the basic voltage command values of three-phase of the object set.

Since the flat-top two-phase modulation and the flat-bottom two-phase modulation of each set become the processing similar to the equation (3), explanation is omitted.

The execution of the flat-top two-phase modulation in the first set and the second set and the execution of the flat-bottom two-phase modulation in the first set and the second set may be replaced periodically. For the first set, as shown in FIG. 7, execution of the flat-top two-phase modulation or the flat-bottom two-phase modulation may be determined; and for the second set, execution of the flat-top two-phase modulation or the flat-bottom two-phase modulation may be determined so as to be the same as the first set. Alternatively, for each of the first set and the second set, as shown in FIG. 7, execution of the flat-top two-phase modulation or the flat-bottom two-phase modulation may be determined. Even in this case, since an interval when the flat-top two-phase modulation and the flat-bottom two-phase modulation are executed in the first set and the second set occurs, the ripple component of the bus current is reduced.

### <Third Example of Bus Current Ripple Suppression Control>

Alternatively, the modulation unit 33b uses the first carrier wave signal C1 as the first set of carrier wave signal; and uses the second carrier wave signal C2 which differs from the first carrier wave signal C1 by 90 degrees in phase as the second set of carrier wave signal. For each set, the modulation unit 33b calculates a third order harmonic wave which makes a center value between a maximum voltage and a minimum voltage in the voltage command values of three-phase coincide with a center value Vdc/2 of the DC voltage; and calculates the voltage command values of three-phase by subtracting the third order harmonic wave from the basic voltage command values of three-phase. Since this modulation of each set becomes the processing similar to the equation (1), explanation is omitted.

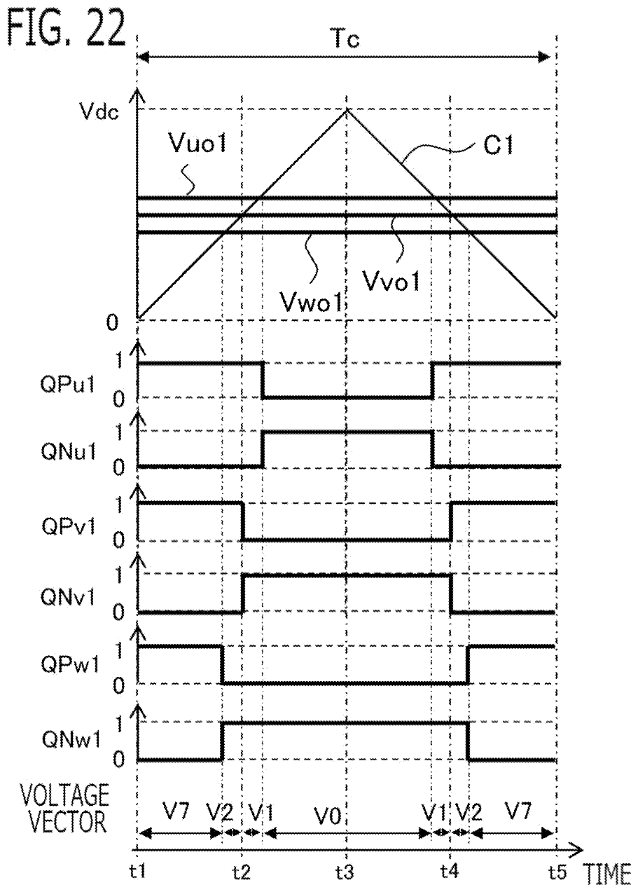

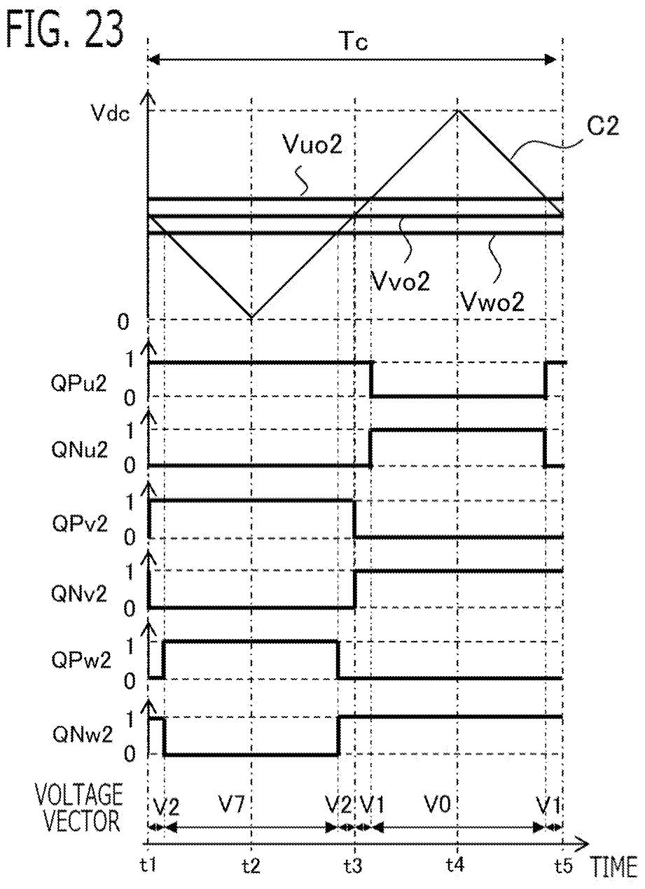

FIG. 22 shows each switching signal by the comparison between the first carrier wave signal C1 and the first set of voltage command values of three-phase Vuo1, Vvo1, Vwo1 in the PWM period Tc, and the voltage vector. FIG. 23 shows each switching signal by the comparison between the second carrier wave signal C2 which differs from the first carrier wave signal by 90 degrees in phase and the second set of voltage command values of three-phase Vuo2, Vvo2, Vwo2, and the voltage vector.

In the case of the first carrier wave signal C1, as shown in FIG. 22, the effective voltage vectors V2, V1 arise centering on the time t2 and the time t4. In the case of the second carrier wave signal C2, as shown in FIG. 23, the effective voltage vectors V2, V1 arise centering on the time t1, the time t3, and the time t5. Accordingly, the interval of the effective voltage vector can be shifted between sets, and the ripple component of the bus current can be reduced. By applying the modulation of the equation (1), each interval of the effective voltage vectors can be set symmetrically before and after, centering on t1, t2, t3, and t4, the shifting effect of the interval of the effective voltage vector between sets can be maximized, and the reduction of the ripple component of the bus current can be maximized.

In each of the above-mentioned embodiments, there was explained the case where the center value of the DC voltage is set to Vdc/2; and the voltage command values of three-phase, the basic voltage command values of three-phase, and the first and second carrier wave signals oscillate centering on Vdc/2. However, the center value of the DC voltage may be set to 0; and the voltage command values of three-phase, the basic voltage command values of three-phase, and the first and second carrier wave signals may oscillate centering on 0. In this case, Vdc/2 are subtracted from the voltage command values of three-phase, the basic voltage command values of three-phase, and the first and second carrier wave signals of each Embodiment.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### REFERENCE SIGNS LIST

2: DC Power Source, 4: Inverter, 30: AC Rotary Machine Controller, 33: Voltage Command Calculation Unit, 34: PWM Control Unit, 100: Vehicle Driving Apparatus, 120: Electric Power Steering Apparatus, C: Carrier Wave Signal, C1: First Carrier Wave Signal, C2: Second Carrier Wave Signal, Vuo, Vvo, Vwo: Voltage Command Values of Three-phase, Vub, Vvb, Vwb: Basic Voltage Command Values of Three-phase

1. An AC rotary machine controller that controls an AC rotary machine having a stator provided with one set or a plurality of sets of three-phase windings via one set or a plurality of sets of inverters, the AC rotary machine controller comprising at least one processor configured to implement:
a voltage command calculator that, for each set, calculates voltage command values of three-phase applied to the three-phase windings; and
a PWM calculator that, for each set, controls on/off a plurality of switching devices of the inverter, based on a comparison result between each of the voltage command values of three-phase and a carrier wave signal;
wherein, for each set, the voltage command calculator switches a first control mode, a second control mode, and a third control mode, based on an operating state of the AC rotary machine;
in the first control mode, the voltage command calculator executes a phase current ripple suppression control that calculates the voltage command values of three-phase by applying a modulation to basic voltage command values of three-phase so that a ripple component of current flowing into the winding of each phase decreases less than a case where the basic voltage command values of three-phase of sine waves are set as the voltage command values of three-phase;
in the second control mode, the voltage command calculator executes a bus current ripple suppression control that calculates the voltage command values of three-phase by applying a modulation to the basic voltage command values of three-phase so that a ripple component of current flowing between a DC power source and the inverter decreases less than a case where the basic voltage command values of three-phase of sine waves are set as the voltage command values of three-phase; and
in the third control mode, the voltage command calculator executes a switching loss suppression control that calculates the voltage command values of three-phase by applying a modulation to the basic voltage command values of three-phase so that a loss of the switching devices decreases less than a case where the basic voltage command values of three-phase of sine waves are set as the voltage command values of three-phase.

2. The AC rotary machine controller according to claim 1,
wherein, for each set, the voltage command calculator switches the first control mode, the second control mode, and the third control mode, based at least on an output parameter which is one of an absolute value of a current vector of currents flowing into the three-phase windings and an absolute value of an output torque of the AC rotary machine, and a region parameter which is one of an absolute value of a rotational speed of the AC rotary machine and an absolute value of a voltage vector of the voltage command values of three-phase.

3. The AC rotary machine controller according to claim 2,
wherein, for each set, the voltage command calculator switches to the first control mode, when the output parameter is smaller than an output determination value, and the region parameter is smaller than a region determination value;
switches to the second control mode, when the output parameter is greater than or equal to the output determination value, and the region parameter is smaller than the region determination value; and
switches to the third control mode, when the region parameter is greater than or equal to the region determination value.

4. The AC rotary machine controller according to claim 1,
wherein, for each set, in the phase current ripple suppression control, the voltage command calculator calculates a third order harmonic wave which makes a center value between a maximum voltage and a minimum voltage in the voltage command values of three-phase coincide with a center value of a DC voltage supplied to the inverter; and calculates the voltage command values of three-phase by subtracting the third order harmonic wave from the basic voltage command values of three-phase.

5. The AC rotary machine controller according to claim 1,
wherein, if two sets of the three-phase windings are provided in the stator, in the phase current ripple suppression control, the voltage command calculator calculates a first set of third order harmonic wave and a second set of third order harmonic wave which make a center value between a maximum voltage and a minimum voltage in first set of the voltage command values of three-phase, and a center value between a maximum voltage and a minimum voltage in second set of the voltage command values of three-phase coincide with each other; calculates the first set of voltage command values of three-phase by subtracting the first set of third order harmonic wave from first set of the basic voltage command values of three-phase; and calculates the second set of voltage command values of three-phase by subtracting the second set of third order harmonic wave from second set of the basic voltage command values of three-phase.

6. The AC rotary machine controller according to claim 1,
wherein, for each set, in the switching loss suppression control, the voltage command calculator calculates an offset voltage which makes the voltage command value of a phase of a maximum voltage in the voltage command values of three-phase coincide with a maximum value of the carrier wave signal, or which makes the voltage command value of a phase of a minimum voltage in the voltage command values of three-phase coincide with a minimum value of the carrier wave signal; and calculates the voltage command values of three-phase by subtracting the offset voltage from the basic voltage command values of three-phase.

7. The AC rotary machine controller according to claim 1,
wherein, for each set, in the switching loss suppression control,
when an absolute value of a winding current of a phase of a maximum voltage in the voltage command values of three-phase is larger than an absolute value of the winding current of a phase of a minimum voltage in the voltage command values of three-phase, the voltage command calculator calculates an offset voltage which makes the voltage command value of the phase of the maximum voltage coincide with a maximum value of the carrier wave signal;
when the absolute value of the winding current of the phase of the maximum voltage is not larger than the absolute value of the winding current of the phase of the minimum voltage, the voltage command calculator calculates the offset voltage which makes the voltage command value of the phase of the minimum voltage coincide with a minimum value of the carrier wave signal; and
the voltage command calculator calculates the voltage command values of three-phase by subtracting the offset voltage from the basic voltage command values of three-phase.

8. The AC rotary machine controller according to claim 1,
wherein, for each set, in the bus current ripple suppression control,
when a phase of a maximum current absolute value in absolute values of currents of three-phase flowing into the three-phase windings coincides with a phase of a maximum voltage in the voltage command values of three-phase, the voltage command calculator executes a flat-top two-phase modulation that calculates an offset voltage which makes the voltage command value of the phase of the maximum voltage coincide with a maximum value of the carrier wave signal, and calculates the voltage command values of three-phase by subtracting the offset voltage from the basic voltage command values of three-phase;
when the phase of the maximum current absolute value coincides with a phase of a minimum voltage in the voltage command values of three-phase, the voltage command calculator executes a flat-bottom two-phase modulation that calculates the offset voltage which makes the voltage command value of the phase of the minimum voltage coincide with a minimum value of the carrier wave signal, and calculates the voltage command values of three-phase by subtracting the offset voltage from the basic voltage command values of three-phase;
as the carrier wave signal, the voltage command calculator uses a first carrier wave signal, and a second carrier wave signal which differs from the first carrier wave signal by 180 degrees in phase; and
for two phases other than the phase of the maximum voltage when executing the flat-top two-phase modulation, or two phases other than the phase of the minimum voltage when executing the flat-bottom two-phase modulation, the voltage command calculator compares the voltage command value of one phase with the first carrier wave signal, and compares the voltage command value of the other phase with the second carrier wave signal.

9. The AC rotary machine controller according to claim 8,
wherein, for each set, in the bus current ripple suppression control,
in a case where the phase of the maximum current absolute value coincides with a phase of a middle voltage in the voltage command values of three-phase, the voltage command calculator executes the flat-top two-phase modulation, when the middle voltage is larger than a center value of a DC voltage supplied to the inverter, and the voltage command calculator executes the flat-bottom two-phase modulation, when the middle voltage is smaller than the center value.

10. The AC rotary machine controller according to claim 8,
wherein, for each set, in the bus current ripple suppression control,
when the phase of the maximum current absolute value coincides with the phase of the maximum voltage in the voltage command values of three-phase, the voltage command calculator switches the carrier wave signal of the phase of the maximum current absolute value to the second carrier wave signal, and
when the phase of the maximum current absolute value coincides with the phase of the minimum voltage in the voltage command values of three-phase, the voltage command calculator switches the carrier wave signal of the phase of the maximum current absolute value to the first carrier wave signal.

11. The AC rotary machine controller according to claim 1,
wherein, if two sets of the three-phase windings are provided in the stator, in the bus current ripple suppression control,
the voltage command calculator executes a flat-bottom two-phase modulation for the second set, when executing a flat-top two-phase modulation for the first set; and executes the flat-top two-phase modulation for the second set, when executing the flat-bottom two-phase modulation for the first set;
as first set of the carrier wave signal and second set of the carrier wave signal, the voltage command calculator uses the carrier wave signals with the same phase;
in the flat-top two-phase modulation, the voltage command calculator calculates an offset voltage which makes the voltage command value of a phase of a maximum voltage in the voltage command values of three-phase of an object set in which the flat-top two-phase modulation is executed coincide with a maximum value of the carrier wave signal; and calculates the voltage command values of three-phase of the object set by subtracting the offset voltage from the basic voltage command values of three-phase of the object set; and
in the flat-bottom two-phase modulation, the voltage command calculator calculates the offset voltage which makes the voltage command value of a phase of a minimum voltage in the voltage command values of three-phase of the object set in which the flat-bottom two-phase modulation is executed coincide with a minimum value of the carrier wave signal; and calculates the voltage command values of three-phase of the object set by subtracting the offset voltage from the basic voltage command values of three-phase of the object set.

12. The AC rotary machine controller according to claim 1,
wherein, if two sets of the three-phase windings are provided in the stator, in the bus current ripple suppression control,
the voltage command calculator executes a flat-top two-phase modulation for the second set, when executing the flat-top two-phase modulation for the first set; and executes a flat-bottom two-phase modulation for the second set, when executing the flat-bottom two-phase modulation for the first set;
the voltage command calculator uses a first carrier wave signal as first set of the carrier wave signal, and uses a second carrier wave signal which differs from the first carrier wave signal by 180 degrees in phase, as second set of the carrier wave signal;
in the flat-top two-phase modulation, the voltage command calculator calculates an offset voltage which makes the voltage command value of a phase of a maximum voltage in the voltage command values of three-phase of an object set in which the flat-top two-phase modulation is executed coincide with a maximum value of the carrier wave signal; and calculates the voltage command values of three-phase of the object set by subtracting the offset voltage from the basic voltage command values of three-phase of the object set; and
in the flat-bottom two-phase modulation, the voltage command calculator calculates the offset voltage which makes the voltage command value of a phase of a minimum voltage in the voltage command values of three-phase of the object set in which the flat-bottom two-phase modulation is executed coincide with a minimum value of the carrier wave signal; and calculates the voltage command values of three-phase of the object set by subtracting the offset voltage from the basic voltage command values of three-phase of the object set.

13. The AC rotary machine controller according to claim 1,
wherein, if two sets of the three-phase windings are provided in the stator, in the bus current ripple suppression control,
for each set, the voltage command calculator calculates a third order harmonic wave which makes a center value between a maximum voltage and a minimum voltage in the voltage command values of three-phase coincide with a center value of a DC voltage supplied to the inverter; and calculates the voltage command values of three-phase by subtracting the third order harmonic wave from the basic voltage command values of three-phase; and
the voltage command calculator uses a first carrier wave signal as first set of the carrier wave signal, and uses a second carrier wave signal which differs from the first carrier wave signal by 90 degrees in phase, as second set of the carrier wave signal.

14. The AC rotary machine controller according to claim 1,
wherein the voltage command calculator executes the bus current ripple suppression control also in the third control mode.

15. A vehicle driving apparatus comprising:
the AC rotary machine controller according to claim 1,
the AC rotary machine, and
a driving force transmission mechanism that transmits a driving force of the AC rotary machine to wheels of a vehicle.

16. An electric power steering apparatus comprising:
the AC rotary machine controller according to claim 1,
the AC rotary machine, and
a driving force transmission mechanism that transmits a driving force of the AC rotary machine to a steering apparatus of a vehicle.
